(19) United States
(12) Patent Application Publication
(10) Pub. No.: US 2025/0390688 A1
(43) Pub. Date: Dec. 25, 2025

(54) LIVE STREAMING TRANSLATION METHOD AND APPARATUS, STORAGE MEDIUM, AND COMPUTER DEVICE

(71) Applicant: Tencent Technology (Shenzhen) Company Limited, Shenzhen (CN)

(72) Inventor: Shangzhen ZHENG, Shenzhen (CN)

(21) Appl. No.: 19/310,759

(22) Filed: Aug. 26, 2025

Related U.S. Application Data
(63) Continuation of application No. PCT/CN2024/104960, filed on Jul. 11, 2024.

(30) Foreign Application Priority Data
Sep. 6, 2023 (CN) 202311146866.9

(51) Int. Cl. G06F 40/58; G06F 40/30; G06F 40/51; H04N 21/2187; H04N 21/233

(52) U.S. Cl. CPC G06F 40/58; G06F 40/30; G06F 40/51; H04N 21/2187; H04N 21/2335

(57) ABSTRACT

This application discloses a live streaming translation method performed by a computer device, including: acquiring a candidate live stream from captured live streams; performing translation processing on speech recognition content corresponding to the candidate live stream, to obtain a translation result corresponding to the candidate live stream; determining a to-be-pushed target translation result based on the translation result corresponding to the candidate live stream and a target end timestamp of a to-be-pushed target live stream; re-encoding the to-be-pushed target live stream based on the target translation result, to obtain a re-encoded live stream; and pushing the re-encoded live stream, to be displayed the target translation result at a viewer end. In this application, a duration threshold is set, so that the target translation result can be acquired and pushed within a time period corresponding to the duration threshold, to improve accuracy of a live streaming translation result.

### CROSS-REFERENCE TO RELATED APPLICATIONS

This application is a continuation application of PCT Patent Application No. PCT/CN2024/104960, entitled “LIVE STREAMING TRANSLATION METHOD AND APPARATUS, STORAGE MEDIUM, AND COMPUTER DEVICE” filed on Jul. 11, 2024, which claims priority to Chinese Patent Application No. 2023111468669, entitled “LIVE STREAMING TRANSLATION METHOD AND APPARATUS, STORAGE MEDIUM, AND COMPUTER DEVICE” filed with the China National Intellectual Property Administration on Sep. 6, 2023, both of which are incorporated by reference in their entirety.

### FIELD OF THE TECHNOLOGY

This application relates to the field of computer technologies, and specifically, to a live streaming translation method and apparatus, a storage medium, and a computer device.

### BACKGROUND OF THE DISCLOSURE

Simultaneous interpretation is a translation manner in which an interpreter interprets content to a listener without interrupting speech of a speaker. With the advancement of computer and information technologies, simultaneous interpretation may now be closely integrated with communication technologies.

For example, automatic translation is performed in a scenario such as live streaming, network live streaming, or a real-time call. In a related technology, in automatic translation of speech of a speaker in a scenario, a translation result corresponding to content of utterance is usually provided after the speaker completes the utterance.

In this automatic translation manner, the content of the utterance of the speaker may be translated. However, to obtain an accurate translation result, it is generally necessary to wait for a translation time during the translation, and the translation result may be inaccurate if a translation result corresponding to a to-be-pushed live stream is delivered to a viewer end in real time. In conclusion, live streaming translation has a poor effect, affecting live streaming viewing experience of a user.

### SUMMARY

Embodiments of this application provide a live streaming translation method and apparatus, a storage medium, and a computer device, to resolve a problem in the related technology that an inaccurate live streaming translation result leads to a poor live streaming translation effect.

According to one aspect, an embodiment of this application provides a live streaming translation method. The method includes: acquiring, from captured live streams, a candidate live stream whose target timestamp is an end time of a translated live stream corresponding to a previous stable translation result; performing translation processing on speech recognition content corresponding to the candidate live stream, to obtain a translation result corresponding to the candidate live stream; determining a to-be-pushed target translation result from the translation result corresponding to the candidate live stream and a target end timestamp of a to-be-pushed target live stream, wherein the to-be-pushed target translation result is a translation result that is to be pushed with the target live stream; re-encoding the to-be-pushed target live stream based on the target translation result, to obtain a re-encoded live stream; and pushing the re-encoded live stream to be displayed with the target translation result at a viewer end.

According to another aspect, an embodiment of this application further provides a computer device. The computer device includes a memory and a processor, the memory storing computer program instructions, and the computer program instructions, when executed by the processor, causing the computer device to perform the above live streaming translation method.

According to another aspect, an embodiment of this application further provides a non-transitory computer-readable storage medium. The computer-readable storage medium stores program code, the program code, when executed by a processor of a computer device, causing the computer device to perform the above live streaming translation method.

According to the live streaming translation method provided in this application, a candidate live stream may be acquired from captured live streams, where the candidate live stream is a live stream whose start time is a target timestamp and whose end time is after the target timestamp, the target timestamp is an end time of a live stream corresponding to a previous stable translation result, the live stream corresponding to the previous stable translation result herein is a translated live stream, the translated live stream is a previous live stream of the candidate live stream, and the previous stable translation result is a stable translation result obtained after translation processing is performed on the translated live stream. Then, in the embodiments of this application, translation processing may be performed on speech recognition content corresponding to the candidate live stream, to obtain a translation result corresponding to the candidate live stream, and a to-be-pushed target translation result may be determined based on the translation result corresponding to the candidate live stream and a target end timestamp of a to-be-pushed target live stream, where the to-be-pushed target translation result is a translation result that is to be pushed with the target live stream, and a time difference between an end time of a live stream corresponding to the target translation result and the target end timestamp does not exceed a preset duration threshold. The duration threshold herein is a positive number, and the duration threshold is configured for representing a maximum delayed pushing duration of the target live stream. Then, in the embodiments of this application, the to-be-pushed target live stream may be re-encoded based on the target translation result, to obtain a re-encoded live stream, and the re-encoded live stream is pushed, to display a translation result in the target translation result at a viewer end. As can be seen, since the time difference between the end time of the live stream corresponding to the target translation result and the target end timestamp does not exceed the preset duration threshold and the start time of the candidate live stream is the end time of the live stream corresponding to the previous stable translation result, the target translation result is equivalent to being obtained by translating a live stream whose duration is longer than a duration of the to-be-pushed target live stream. Therefore, in a network live streaming scenario, when live streaming translation is performed by using the live streaming translation method, a live stream has a longer duration. Therefore, a more complete and accurate target translation result may be obtained by translating the live stream with a longer duration.

Therefore, in this application, compared with directly translating speech recognition content corresponding to the to-be-pushed target live stream and re-encoding the translation result corresponding to the target live stream into the target live stream, a target encoding result finally obtained by using a live stream with a longer duration involved in the embodiments of this application has higher accuracy. Therefore, when a relatively accurate target translation result obtained by translation is pushed, live streaming translation can ensure accurate translation quality. In addition, since the time difference between the end time of the live stream corresponding to the target translation result and the target end timestamp does not exceed the duration threshold, under the premise of ensuring that a duration during which the target live stream is delayed in being pushed at most (i.e., the maximum delayed pushing duration) is within the above duration threshold, accuracy of continuous live streaming translation performed in real time in the network live streaming scenario may be ensured by sacrificing real-time performance of some live streaming, so that live streaming viewing experience of a user in the entire network live streaming scenario can be improved by using the target translation result obtained by translation.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description are only some embodiments of this application, and a person skilled in the art may still derive other drawings from these accompanying drawings without creative efforts.

FIG. 1 is a schematic architectural diagram of a live streaming translation system according to an embodiment of this application.

FIG. 2 is a diagram of an application scenario of a live streaming translation method according to an embodiment of this application.

FIG. 3 is a schematic flowchart of a live streaming translation method according to an embodiment of this application.

FIG. 4 is a schematic flowchart of determining a target translation result according to an embodiment of this application.

FIG. 5 is a flowchart of a translation process according to an embodiment of this application.

FIG. 6 is a schematic flowchart of a live streaming translation method according to another embodiment of this application.

FIG. 7 is a flowchart of live streaming translation according to an embodiment of this application.

FIG. 8 is a schematic diagram of a bitstream format of a network abstraction layer (NAL) data unit according to an embodiment of this application.

FIG. 9 is a schematic diagram of a data format of supplemental enhancement information (SEI) according to an embodiment of this application.

FIG. 10 is a block diagram of modules of a live streaming translation apparatus according to an embodiment of this application.

FIG. 11 is a block diagram of modules of a computer device according to an embodiment of this application.

FIG. 12 is a block diagram of modules of a computer-readable storage medium according to an embodiment of this application.

### DESCRIPTION OF EMBODIMENTS

In specific implementations of this application, related data such as audios, videos, live streams of a user is involved. When the data is applied to specific products or technologies of embodiments of this application, permission or consent of the user is required, and collection, use, and processing of the related data need to comply with related laws, regulations, and standards of related countries and regions. Moreover, subsequent data use and processing behaviors are carried out within authorized scopes of laws and regulations and a personal information subject.

Currently, different languages have respective particular grammars and expression manners, but after an audio that expresses a complete statement is acquired, the audio that expresses the complete statement needs to be further translated according to a complete statement translation manner (that is, an offline translation manner), to obtain a translation result corresponding to the audio that expresses the complete statement. However, in a live streaming scenario, since a live stream needs to be pushed to a viewer end in real time and a live stream pushed each time has a relatively short duration, if speech recognition content of an audio in the live stream pushed each time is directly translated in a live streaming translation manner and a translation result is pushed to the viewer end together with the currently pushed live stream, it means that once the audio in the live stream cannot completely express speech content of a speaker (that is, a livestreamer), a translation result of the live stream obtained by real-time translation by using the live streaming translation manner may be inaccurate. In this way, when the live stream and the translation result of the live stream are pushed together to the viewer end, the translation result of the live stream displayed on the viewer end may also be inaccurate, thereby affecting live streaming viewing experience of a viewer in the live streaming scenario.

However, each time after the speaker (that is, the livestreamer) finishes one or more sentences, speech recognition content of an audio in the live stream is translated, and then a translation result and the live stream are delivered to the viewer end. This easily causes a severe delay in live streaming. In addition, real-time performance of live streaming translation is relatively poor, and a problem that a translation result presented to the viewer is not synchronized with an audio and video picture decoded from the live stream may occur, which affects live streaming viewing experience of the viewer and may further affect interaction between the livestreamer and the viewer. To resolve the foregoing problem, upon research, the inventor proposes a live streaming translation method in this application.

The live streaming translation method in this application relates to a streaming media technology, and specifically refers to a technology and a process of compressing a series of media data, transmitting the data in segments over the Internet, and transmitting audiovisual content instantly over the Internet for viewing. Streaming transmission enables transmission of live audiovisual content or videos pre-stored on a server. After audiovisual data of the live audiovisual content or the videos is transmitted to a computer device of a viewer, particular playback software on the computer device may immediately play back the received audiovisual data (i.e., audio and video data), so that the viewer can view the live audiovisual content or the videos pre-stored on the server. A live streaming application related to the streaming broadcast translation method provided in this application is taken as an example.

The live streaming translation method as referred to in this application is a method for transmitting and playing back live audiovisual data by using the streaming media technology in the live streaming scenario. The live streaming translation method may be applied to network live streaming, online video conferencing, and the like. For example, during live streaming, when a livestreamer end corresponding to the livestreamer is integrated with the foregoing live streaming application, a camera may be called by using the live streaming application, to collect a video frame picture associated with the livestreamer, and video coding may be performed on the collected video frame picture by using a video coding protocol (for example, an H.264 coding protocol), to obtain video coded content (that is, a video stream or a video coded stream) for the livestreamer. At the same time, the livestreamer end corresponding to the livestreamer may further call a microphone by using the live streaming application, to collect audio data associated with the livestreamer and may perform audio coding on the collected audio data by using an audio coding protocol, to obtain audio coded content (that is, an audio stream or an audio coded stream) for the livestreamer. Then, the livestreamer end may perform streaming media encapsulation processing (for example, perform the foregoing media data compression processing) on the currently obtained video coded content (that is, the video stream) and the audio coded content (that is, the audio stream) by using a streaming media format indicated by the streaming media technology, to obtain a live streaming data stream for pushing to the server. Specifically, an H.264 coding framework includes a video coding layer (VCL) and a NAL. The VCL is configured for efficient video content representation. The NAL is configured to format data and provide header information, to ensure that the data is suitable for effective transmission over various channels and storage media.

The video content representation includes an I frame generated by performing intra-frame compression on a video frame (that is, the foregoing video frame picture) and a P and/or B frame generated by performing inter-frame compression on the video frame. Herein, the I frame is a complete coded key frame, the P frame is a forward predictive coded frame, and the B frame is a bidirectional predictive interpolated coded frame. In the NAL, a network abstract layer unit (NALU) is a basic unit for coding, storage, or transmission by using the H.264 coding protocol.

Each NALU includes a header structure and a payload. The header structure occupies 1 byte (8 bits), and the header structure indicates whether the corresponding NALU (that is, the NALU in which the header structure is located) in the NAL may be discarded, an importance indication, and a NALU type. In an H.264 bitstream, each frame of data is a NALU. For example, in this embodiment of this application, an auxiliary enhanced frame generated based on a target translation result is a custom data field that adds the target translation result to SEI and is encapsulated into a NALU of a particular type.

To prevent problems of a huge load of the server caused by excessive user traffic and excessively slow downloading speeds during peak user traffic, in the live streaming scenario, the data may be delivered by using a content delivery network (CDN). The CDN includes two layers: a center and an edge. Edge servers in an edge layer are deployed in various places and across major carriers, and physical distances between the edge servers and the user are the shortest. A streaming media service cluster in a center layer is responsible for content forwarding. For example, according to geographical position information of the user, the nearest edge server is selected to provide stream pushing/pulling services for the user. In this embodiment of this application, the stream pushing service provided by the edge server for the user refers to a service that the edge server, after acquiring a live stream of the livestreamer, may intelligently push the acquired live stream of the livestreamer to the viewer end. Similarly, the stream pulling service provided by the edge server for the user refers to a service that the edge server may pull a live stream of the livestreamer from the livestreamer end.

A system architecture of a live streaming translation method as referred to in this application is first described below.

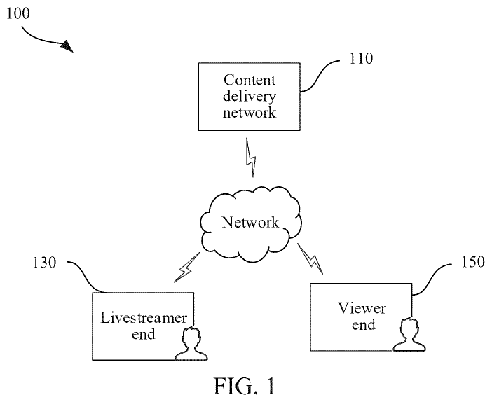

Referring to FIG. 1, FIG. 1 is a schematic architectural diagram of a live streaming translation system according to an embodiment of this application. As shown in FIG. 1, a live streaming translation system 100 may include a CDN 110, a livestreamer end 130, and a viewer end 150. The livestreamer end 130 and the viewer end 150 may be terminal devices, such as smartphones, desktop computers, tablet computers, notebook computers, smart televisions, vehicle-mounted devices, augmented reality (AR), and virtual reality (VR), which are not limited herein.

The CDN 110 may include an edge server and a streaming media service cluster. The streaming media service cluster may include a plurality of streaming media servers. The edge server and the streaming media server each may be a standalone physical server, may be a server cluster or a distributed system including a plurality of physical servers, or may be a cloud server providing basic cloud computing services such as a cloud service, cloud computing, a cloud function, cloud storage, cloud communication, a network service, a domain name service, a middleware service, a security service, a blockchain, big data, and an AI platform, which are not limited herein.

In some embodiments of this application, the livestreamer end 130, after collecting the live stream, may perform translation processing on the live stream based on the live streaming translation method as referred to in this application, to obtain a live stream carrying a translation result (that is, the re-encoded live stream in this application). Further, the livestreamer end 130 may push the live stream carrying the translation result to the CDN 110. Then, the viewer end 150 may pull and decode a stream from the CDN 110, to obtain an audio and video carrying subtitle content (the subtitle content includes at least the translation result, or may include the translation result and speech recognition content corresponding to an audio). The speech recognition content corresponding to the audio (that is, audio data) may be speech text data (for example, speech-converted text data) corresponding to audio data of the livestreamer that is recognized when the livestreamer speaks in a language (for example, a first language). The translation result herein refers to translated text data (for example, translated subtitles) that is expressed in another language (for example, a second language) and obtained by performing simultaneous interpretation on the recognized audio data of the livestreamer. The first language and the second language herein may include, but are not limited to, speeches such as English and Chinese, and specific language types of the first language and the second language are not limited herein.

In other words, “pull and decode a stream” herein specifically means that the viewer end 150 may pull a live stream carrying a translation result (i.e., the re-encoded live stream in this application) from the CDN 110, and decode the pulled re-encoded live stream to obtain an audio and video carrying the translation result (i.e., audio and video data carrying the translation result). In this way, when playing back the audio and video, the viewer terminal 150 may also display subtitle content (for example, a translation result, that is, translated subtitles) obtained by decoding on a screen.

FIG. 1 is only a schematic architectural diagram of a system according to an embodiment of this application. The architecture of the system described in this embodiment of this application is intended to describe the technical solution of this embodiment of this application more clearly, and does not constitute a limitation on the technical solution of this embodiment of this application. For example, in FIG. 1, a process of performing translation processing on a live stream is performing translation by a livestreamer end and then pushing the live stream to a CDN.

In some embodiments, in other cases, the livestreamer end may alternatively push the live stream to a live streaming server, and the live streaming server performs translation processing on the live stream according to the live streaming translation method as referred to in this application, to obtain a translation result of the live stream. Further, the live streaming server may upload the live stream carrying the translation result (that is, the re-encoded live stream) to the CDN. In this way, after pulling and decoding a stream from the CDN, the viewer end may obtain an audio and video with the translation result, so that the audio and video with the translation result may be played back on a screen of the viewer end. For example, when a video frame picture of a livestreamer is displayed on the screen of the viewer end by using a player called by a live streaming application, audio data of the livestreamer may be synchronously played back, and a translation result corresponding to the audio data is displayed.

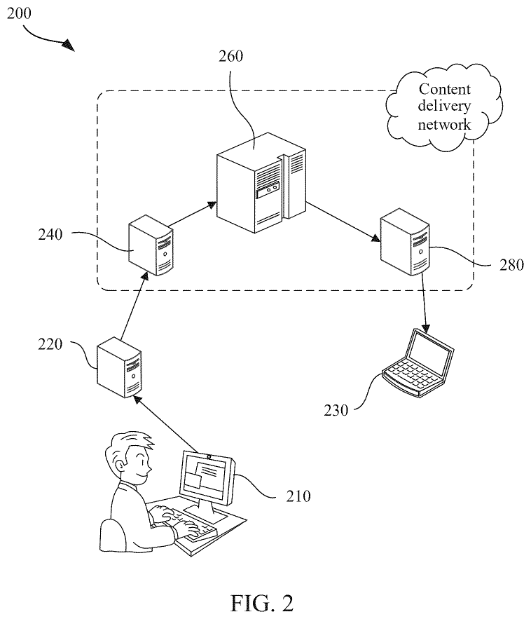

Referring to FIG. 2, FIG. 2 is a diagram of an application scenario of a live streaming translation method according to an embodiment of this application. As shown in FIG. 2, the live streaming translation method may be applied to a computer system 200. The computer system 200 may be applied to a network live streaming scenario. The computer system 200 may include a live streaming server (or backend) 220 of a live streaming media service provider, a user-side live streaming end 210, and a viewer end 230. The CDN includes a streaming media service cluster 260, a first edge server 240 corresponding to the live streaming end 210, and a second edge server 280 corresponding to the viewer end 230.

In the network live streaming scenario, when a livestreamer performs network live streaming by using the live streaming end 210, the live streaming end 210 may encode audios and videos collected in real time into a live stream, and then push the live stream to the live streaming live streaming server 220. Then, after receiving the live stream, the live streaming live streaming server 220 may further cache the live stream received in real time, and perform live streaming translation processing (that is, translation processing) on the captured live stream according to the live streaming translation method as referred to in this application, to obtain a re-encoded live stream, and may further push the re-encoded live stream to the first edge server 240 in the CDN.

Further, as shown in FIG. 2, the first edge server 240 may push the re-encoded live stream to the streaming media service cluster 260. After receiving the re-encoded live stream, the streaming media service cluster 260 may perform processing on the re-encoded live stream, for example, transcoding, that is, converting from one coding format to another coding format. This is because different viewers use different clients and it is necessary to ensure that the viewers can normally view the live stream. Then, the re-encoded live stream (or a re-encoded live stream after transcoding) is pre-loaded to an edge server close to the viewer end, for example, the second edge server 280. In this case, the viewer end 230 may pull the re-encoded live stream (or the re-encoded live stream after transcoding) from the second edge server 280, decode the re-encoded live stream (or the re-encoded live stream after transcoding), to obtain an audio and video of the livestreamer and a translation result corresponding to the audio and video by decoding, and may display the translation result (such as translated subtitles) corresponding to the corresponding audio on a video picture (that is, the foregoing video frame picture) of the livestreamer while the audio and video obtained by decoding is played back.

FIG. 2 is only a diagram of an application scenario of a system according to an embodiment of this application. The architecture of the system described in this embodiment of this application is intended to describe the technical solution of this embodiment of this application more clearly, and does not constitute a limitation on the technical solution of this embodiment of this application. For example, the first edge server 240 may generally refer to one of a plurality of edge servers deployed in the CDN, and the second edge server 280 may also generally refer to one of the plurality of edge servers deployed in the CDN. In this embodiment, only the first edge server 240 and the second edge server 280 are taken as an example for description. A person of ordinary skill in the art may learn that, with the evolution of the system architecture, the technical solution provided in this embodiment of the present disclosure is also applicable to similar technical problems.

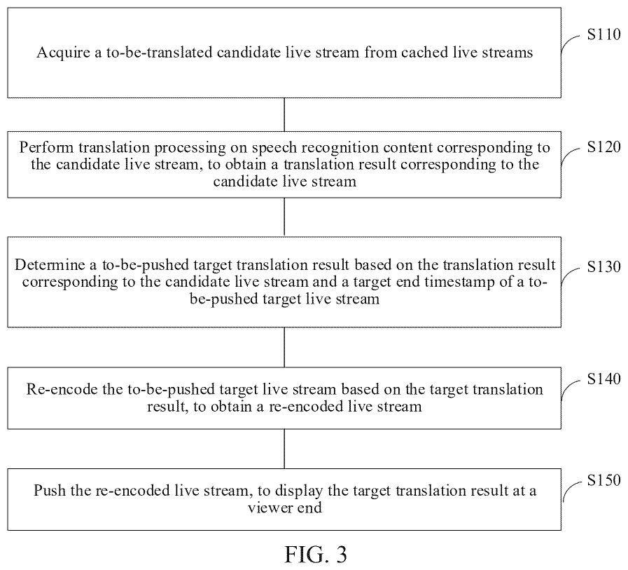

Referring to FIG. 3, FIG. 3 is a schematic flowchart of a live streaming translation method according to an embodiment of this application. In this embodiment of this application, the live streaming translation method may be performed by a computer device. The computer device herein may be a live streaming server and/or a livestreamer end. In other words, the live streaming translation method as referred to in this embodiment of this application may be specifically performed by the live streaming server, or performed by the livestreamer end, or performed by interaction between the live streaming server and the livestreamer end, which is not specifically limited herein. For ease of understanding, as shown in FIG. 3, herein, based on an example in which the live streaming translation method is performed by a live streaming server, the live streaming translation method may specifically include the following operation S110 to operation S150:

Operation S110: Acquire a candidate live stream from captured live streams; the candidate live stream being a live stream whose start time is a target timestamp and whose end time is after the target timestamp; and the target timestamp being an end time of a live stream corresponding to a previous stable translation result.

Generally, the livestreamer end may perform audio collection and video collection in real time when the livestreamer initiates live streaming. The audio collection means that when the livestreamer end is integrated with the live streaming application, a corresponding audio collection device (for example, a microphone carried in the livestreamer end or a microphone externally connected to the livestreamer end) may be called by using the live streaming application, to capture or collection an audio signal (that is, an analog signal) of the livestreamer in real time according to a preset audio sampling rate, and perform audio processing (such as time-frequency spectrum conversion) on the audio signal collected or acquired in real time. Further, after audio processing, audio signals may be collectively referred to as audio data of the livestreamer that is collected in real time. Similarly, the video collection means that when the livestreamer end is integrated with the live streaming application, a corresponding video collection device (for example, a camera carried in the livestreamer end or a camera externally connected to the livestreamer end) may be called by using the live streaming application, to collect video frame pictures of the livestreamer in real time, and video frame pictures of the livestreamer collected in real time may be collectively referred to as collected video data. In other words, in this embodiment of this application, when the livestreamer initiates live streaming, a livestreamer terminal may acquire audio data and video data of the livestreamer in real time, and may collectively refer to the collected audio data and video data as audio and video data.

Then, the livestreamer end may encode the audio and video data collected in real time (that is, the collected audio data and video data), and refer to the encoded audio and video data as an audio and video stream (or an audio and video bitstream, that is, the foregoing live stream) obtained by encoding. In this embodiment of this application, in the process of collecting the audio and video data, the livestreamer end may alternatively first pre-process audio and video data (that is, audio data and video data) that is currently collected in real time (for example, perform beautification, a filter, or a special effect on the collected video data, and perform echo cancellation or noise reduction on the collected audio data), and then encode the preprocessed audio and video data, so as to obtain, by encoding, an audio and video stream (or an audio and video bitstream, that is, the foregoing live stream) that may be transmitted. In this embodiment of this application, the audio and video stream (that is, the foregoing live stream) may specifically include: an audio stream obtained by encoding the audio data and a video stream obtained by encoding the video data.

Further, the livestreamer end may push the audio and video stream obtained by encoding to a backend corresponding to the live streaming application (that is, the live streaming server). Specifically, the livestreamer end may push, based on a streaming media protocol, the live stream obtained by encoding to the live streaming server. In this embodiment of this application, in the network live streaming scenario, the live streaming server is a server configured to provide a live streaming service. The streaming media protocol may include a real-time messaging protocol (RTMP), or an HTTP-based adaptive bitrate streaming protocol (HTTP live streaming, (HLS)), which is not limited herein.

As an implementation, when receiving the live stream pushed by the livestreamer end, the computer device (for example, the live streaming server) may cache the live stream, to facilitate subsequent processing such as translation on the live stream. For example, the live streaming server may cache the received live stream to a bitstream buffer pool and then acquire a to-be-translated live stream, that is, a candidate live stream, from live streams captured in the bitstream buffer pool. Specifically, the live streaming server may acquire an end time of a live stream corresponding to a previous stable translation result, that is, a target timestamp.

Further, the computer device (for example, the live streaming server) may acquire, from the captured live streams, a live stream as the candidate live stream by taking the target timestamp as a start time. The stable translation result is a translation result in a steady state. That is, the stable translation result is a translation result that may not be changed based on subsequent translation processing on the live stream (for example, the candidate live stream herein). Alternatively, the stable translation result is a translation result corresponding to an audio with substantially complete semantics (for example, an audio corresponding to a sentence), and content of the translation result thereof (that is, the foregoing audio with substantially complete semantics) may not be changed with subsequent translation processing on the live stream (for example, the candidate live stream herein).

For example, the livestreamer end 210 as shown in FIG. 2 may acquire audios (that is, audio data) and videos (video data) in a live streaming process when the livestreamer initiates live streaming, and encode the audio data and the video data that are acquired in real time, to obtain a live stream by encoding. After the livestreamer end 210 pushes (i.e., transmits via stream pushing) the encoded live stream to the live streaming server 220, the live streaming server 220 may store the live stream pushed by the livestreamer end to the bitstream buffer pool. Further, the live streaming server 220 may acquire a target timestamp corresponding to the previous stable translation result. For example, the target timestamp is 08:34.17, and then a live stream starting from 08:34.17 is selected from the bitstream buffer pool as a candidate live stream.

In this embodiment of this application, if the computer device configured to perform the live streaming translation method is a live streaming server, the bitstream buffer pool may be configured for caching, in real time, live streams encoded and uploaded by the livestreamer end. A live stream refers to an audio and video bitstream obtained by encoding, based on a sampling duration indicated by a corresponding sampling rate, audio and video data collected in real time.

Based on this, any live stream captured in the bitstream buffer pool corresponds to a duration (which may be, for example, a sampling duration), and sample durations corresponding to different live streams respectively correspond to a start timestamp corresponding to a start time and an end timestamp corresponding to an end time. To ensure continuity and uninterruption of live streaming data in the network live streaming scenario, it is proposed in this embodiment of this application that when acquiring a current to-be-translated live stream from the bitstream buffer pool, the live streaming server may quickly acquire an end time corresponding to a live stream of a previous stable translation result (that is, a current stable translation result most recently obtained) obtained by using the live streaming translation method, and an end time corresponding to the live stream of the previous stable translation result (that is, the current stable translation result most recently obtained) is taken as an initial time of the current to-be-translated live stream, so that the bitstream buffer pool may be searched for a live stream whose initial time is the end time corresponding to the live stream of the previous stable translation result (that is, the current stable translation result most recently obtained) and the found live stream is taken as a current to-be-translated candidate live stream.

In this embodiment of this application, the candidate live stream is a current to-be-translated live stream, and the live stream corresponding to the previous stable translation result is a currently translated live stream. Since an end timestamp of the currently translated live stream is a start timestamp of the current to-be-translated live stream, the currently translated live stream may be considered as a live stream that has been translated and has a stable translation result before the candidate live stream. For example, in an implementable manner, the live stream of the previous stable translation result may specifically be a previous live stream of the candidate live stream (which is, for example, essentially a live stream acquired from the bitstream buffer pool last time relative to the candidate live stream acquired this time), and translation results obtained after translation processing is performed on the previous live stream by using the live streaming translation method are collectively referred to as the previous stable translation result. In other words, the translation result of the previous live stream may be a stable translation result acquired last time (that is, the previous stable translation result).

More specifically, a live stream whose start time is the target timestamp and whose end time is an end time of a live stream most recently captured in the bitstream buffer pool may be acquired from the bitstream buffer pool as the candidate live stream. For example, if the end time of the live stream most recently captured in the bitstream buffer pool is 08:34.23 and the target timestamp is 08:34.17, a live stream within a time period from 08:34.17 to 08:34.23 may be taken as the candidate live stream. In this case, since a new live stream is captured in the bitstream buffer pool in real time, for two adjacent candidate live streams acquired from the bitstream buffer pool, end times of the two adjacent candidate live streams acquired from the bitstream buffer pool are different. The two adjacent candidate live streams acquired from the bitstream buffer pool specifically refer to a live stream acquired from the bitstream buffer pool this time (that is, the to-be-translated candidate live stream herein) and a live stream acquired from the bitstream buffer pool last time (for example, the foregoing translated live stream). In other words, the two adjacent candidate live streams acquired from the bitstream buffer pool specifically refer to the to-be-translated candidate live stream and a previous live stream of the to-be-translated candidate live stream (for example, the foregoing translated live stream).

In some embodiments, in another implementable manner, the two adjacent candidate live streams acquired from the bitstream buffer pool may further specifically refer to a live stream acquired from the bitstream buffer pool this time (that is, the to-be-translated candidate live stream herein) and a new live stream acquired from the bitstream buffer pool next time. In this embodiment of this application, a start time of the new live stream acquired from the bitstream buffer pool next time (for example, a new candidate live stream) may be the same as a start time of a candidate live stream acquired from the bitstream buffer pool this time (both are the target timestamp). For example, after live streaming translation is performed on the candidate live stream acquired from the bitstream buffer pool this time, if no stable translation result exists in a translation result of the candidate live stream acquired this time, the target timestamp is not updated. This means that a start time of a new live stream acquired from the bitstream buffer pool next time (for example, a new candidate live stream) is still the target timestamp, but a duration of the new live stream (for example, the new candidate live stream) is longer than that of the old live stream (for example, the current candidate live stream). Similarly, the start time of the new live stream acquired from the bitstream buffer pool next time (for example, the new candidate live stream) may alternatively be different from the start time of the candidate live stream acquired from the bitstream buffer pool this time. For example, after the live streaming translation is performed on the candidate live stream acquired from the bitstream buffer pool this time, if a stable translation result exists in a translation result of the candidate live stream acquired this time, the start time of the new live stream acquired from the bitstream buffer pool next time (for example, the new candidate live stream) may be a new target timestamp, and the new target timestamp is an end time of the candidate live stream acquired from the bitstream buffer pool this time.

Operation S120: Perform translation processing on speech recognition content corresponding to the candidate live stream, to obtain a translation result corresponding to the candidate live stream.

Specifically, when acquiring a candidate live stream, the computer device (for example, the live streaming server) may decode the candidate live stream, to obtain audio and video data corresponding to the candidate live stream, acquire, from the audio and video data, audio data on which speech recognition is to be performed, perform speech recognition on the audio data, to obtain corresponding speech recognition content, and then perform translation processing on the speech recognition content, to obtain a translation result corresponding to the candidate live stream. For example, translation processing (e.g., English-to-Chinese translation) may be performed on speech recognition content that is expressed in English (that is, the foregoing first language) and obtained by speech recognition, to obtain, by translation, translated text data (that is, translated text content, for example, the foregoing translated subtitles) expressed in Chinese (that is, the foregoing second language).

In this embodiment of this application, translation processing (for example, Chinese-to-English translation) may alternatively be performed on recognized speech recognition content expressed in Chinese, to obtain, by translation, translated text data expressed in English.

The first language refers to a language in which the livestreamer speaks during live streaming when the livestreamer initiates the live streaming by using the livestreamer end. The second language herein refers to a preset language that is flexibly set by a viewer to translate the first language when the viewer views live streaming by using a viewer terminal. In other words, in this embodiment of this application, during speech recognition, it is necessary to recognize a language (that is, the first language), in which the livestreamer speaks, from audio data obtained by decoding and acquire a second language preset by a viewer currently accessing the live streaming room in which the livestreamer is located, so that when speech recognition content corresponding to the audio data is acquired by speech recognition, language recognition content expressed in the first language may be translated into translated text data expressed in the second language (that is, translated text content, for example, the foregoing translated subtitles).

In some embodiments, a speech recognition model and a text translation model may be deployed. The speech recognition model and the text translation model may be models constructed by using a neural network. The foregoing candidate live stream is a to-be-translated live stream. Since the live stream refers to an audio and video stream obtained by encoding audio and video data acquired by the livestreamer end in real time, the audio and video stream herein may specifically include an audio stream obtained by performing audio coding on audio data and a video stream obtained by performing video coding on video data.

In this way, after acquiring the candidate live stream, the live streaming server may decode an audio stream in the candidate live stream (for ease of distinction, the audio stream is referred to as a candidate audio stream), to input audio data corresponding to the audio stream obtained by decoding to the speech recognition model to perform speech recognition on the audio data by using the speech recognition model, and output, by using the speech recognition model, speech recognition content corresponding to the candidate audio stream, that is, speech recognition content corresponding to the candidate live stream. Subsequently, the live streaming server may input the speech recognition content corresponding to the candidate live stream into the text translation model to perform text translation, to output a translation result corresponding to the speech recognition content. That is, the translation result corresponding to the candidate live stream includes a translation result corresponding to the speech recognition content corresponding to the candidate live stream.

In some embodiments, a speech recognition model configured to perform speech recognition on an audio in a first language (the first language is a language used by the livestreamer when the livestreamer performs live streaming by using the livestreamer end) may be deployed according to the first language, and a text translation model configured to translate text in the first language into text in a second language (the second language is a language for a translated text pre-specified when the viewer views live streaming) may be deployed according to the first language and the second language, for example, a text translation model that translates Mandarin Chinese into English, and in another example, a text translation model that translates English into German.

As an implementation, the live streaming server may combine the translation result corresponding to the speech recognition content corresponding to the candidate live stream (for example, the foregoing translated subtitles), the end time and the start time corresponding to the candidate live stream, and the target timestamp (that is, the end time of the live stream corresponding to the previous stable translation result), to obtain the translation result corresponding to the candidate live stream.

In some embodiments, after obtaining, by translation, the translation result corresponding to the speech recognition content corresponding to the candidate live stream (for example, the foregoing translated subtitles), the text translation model may combine the translation result corresponding to the speech recognition content corresponding to the candidate live stream (for example, the foregoing translated subtitles), the speech recognition content corresponding to the candidate live stream, the end time and the start time corresponding to the candidate live stream, and the target timestamp (that is, the end time of the live stream corresponding to the previous stable translation result), to obtain the translation result corresponding to the candidate live stream. Certainly, in another embodiment, the translation result corresponding to the speech recognition content corresponding to the candidate live stream and the speech recognition content corresponding to the candidate live stream may alternatively be combined as the translation result corresponding to the candidate live stream.

In other words, in this embodiment of this application, the translation result may include at least the translation result corresponding to the speech recognition content corresponding to the candidate live stream. In some embodiments, in one or more implementable manners, the translation result may further include one or more of the speech recognition content corresponding to the candidate live stream, the start time and the end time corresponding to the candidate live stream, and an end time of a live stream corresponding to currently acquired stable content (for example, the previous stable translation result).

In this embodiment of this application, the stable content (that is, the previous stable translation result) refers to a statement that is considered by a translator to be complete and may not change a translation result thereof with content of subsequent speech. After an end time of the stable content (that is, the previous stable translation result) is acquired, the end time of the stable content (that is, the previous stable translation result) may be taken as the foregoing target timestamp (that is, denoted as stamp), so that when a translation content selector subsequently acquires a to-be-translated candidate live stream from the bitstream buffer pool, a live stream whose start time is before the stamp may be directly skipped, and a live stream whose start time is the target timestamp and whose end time is after the target timestamp is selected as the candidate live stream. In other words, in this embodiment of this application, the live streaming server may select, from the bitstream buffer pool by using the translation content selector, audio data in a live stream whose start time is at least after the stamp (that is, a live stream whose start time exceeds the stamp or audio data in the live stream may be selected) and transmit the audio data to the translator for translation. In this way, a data volume of translation of the translator can be reduced, and a translation speed at which the translator performs translation processing by using the foregoing text translation model can also be increased.

The translator refers to a tool that may be configured to perform speech recognition and translation on an audio stream or audio data in the audio stream. For example, in this embodiment of this application, the audio stream or the audio data obtained by decoding from the audio stream may be inputted to the translator, then speech recognition content expressed in the first language in the audio data may be recognized by using the speech recognition model in the translator, and then the recognized speech recognition content expressed in the first language may be quickly translated by using the text translation model in the translator, to obtain the translation result corresponding to the speech recognition content corresponding to the candidate live stream (for example, the foregoing translated subtitles expressed in the second language).

Operation S130: Determine a to-be-pushed target translation result based on the translation result corresponding to the candidate live stream and a target end timestamp of a to-be-pushed target live stream; a time difference between an end time of a live stream corresponding to the target translation result and the target end timestamp not exceeding a duration threshold.

The target live stream refers to a current to-be-pushed live stream. In this application, for ease of distinction, a timestamp representing an end time of the target live stream is referred to as the target end timestamp.

In some embodiments, a duration of a live stream pushed each time may be set and is assumed to be a first duration. If an end time of a previously pushed live stream is a first time, a live stream whose start time is the first time and whose end time is a second time (the second time=the first time+the first duration) may be obtained from the captured live streams (for example, the live streams captured in the bitstream buffer pool in the foregoing description) as the current to-be-pushed target live stream. In the live streaming scenario, a live stream in a same time period may not be repeatedly pushed. Therefore, two adjacently pushed live streams are different, and an end time of a previously pushed live stream may generally be a start time of a subsequently pushed live stream, to ensure that the two adjacently pushed live streams are different.

In this application, the candidate live stream is a live stream that is selected by the translation content selector from the bitstream buffer pool and whose end time is after the target timestamp (that is, the end time of the live stream corresponding to the previous stable translation result), that is, the start time of the candidate live stream is the target timestamp, and the end time is after the target timestamp. Therefore, the start time of the candidate live stream is no later than the start time of the current to-be-pushed target live stream, that is, the start time of the candidate live stream may be earlier than the start time of the target live stream. If a previous pushed translation result is a stable translation result, the start time of the current candidate live stream may be equal to the start time of the target live stream.

In addition, in this application, the end time of the candidate live stream is no earlier than the end time of the target live stream, that is, the end time of the candidate live stream may be the same as the end time of the target live stream, or the end time of the candidate live stream may be later than the end time of the target live stream. In other words, a live streaming time period corresponding to the target live stream is within a live streaming time period corresponding to the candidate live stream, or the live streaming time period corresponding to the target live stream is the same as the live streaming time period corresponding to the candidate live stream.

The to-be-pushed target translation result is a translation result that is to be pushed with the target live stream. In this application, the duration threshold is a positive number. Since the time difference between the end time of the live stream corresponding to the target translation result and the target end timestamp does not exceed the duration threshold, if the end time of the live stream corresponding to the target translation result is no later than (that is, earlier than) the target end timestamp (that is, the end time of the target live stream) and a difference between the end time of the live stream corresponding to the target translation result and the target end timestamp is greater than or equal to the duration threshold, stable content that may be pushed with the target live stream has been currently acquired before the target end timestamp (that is, a stable translation result obtained by most recent translation currently exists in the translation result corresponding to the candidate live stream obtained by translation this time).

In a common live streaming scenario, when a current to-be-pushed target live stream is read, the to-be-pushed target live stream is pushed in real time, generally without additional waiting. However, in this application, if the end time of the live stream corresponding to the target translation result is later than the target end timestamp, after the current to-be-pushed target live stream is read, there is a need to continue to wait for a period of time to obtain a complete stable translation result that may not change with content of subsequent speech.

In this period of waiting, if a new live stream is captured, in this case, a currently obtained live stream (that is, the foregoing target live stream, in this case, the target live stream herein is the foregoing candidate live stream) and a live stream newly obtained in this period of waiting may be combined into a new candidate live stream having a longer duration and obtained from the captured live streams, and then the new candidate live stream may be taken as a data basis for translation by the translator. In this way, compared with the fact that only the speech recognition content corresponding to the target live stream is taken as a data basis for translation, in this case of this application, more data bases for translation may be obtained. In the live streaming scenario, if a live stream serving as a data basis for translation corresponds to a longer duration, there is a higher probability that the live stream includes a complete one-sentence audio stream, and correspondingly, a translation result obtained by translation based on speech recognition content of the live stream has higher accuracy.

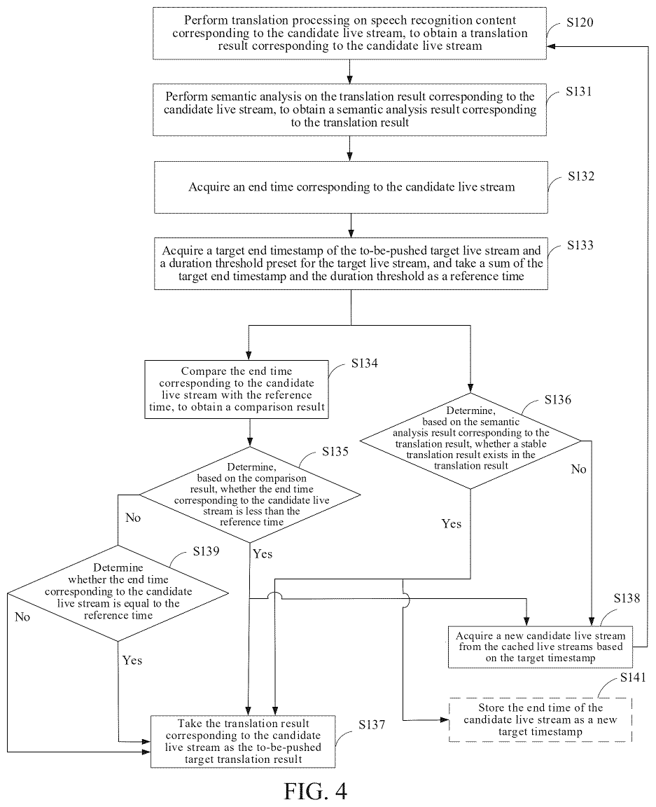

As an implementation, semantic analysis may be performed on the translation result corresponding to the candidate live stream, to determine the target translation result. Specifically, referring to FIG. 4, FIG. 4 is a schematic flowchart of determining a target translation result according to an embodiment of this application. As shown in FIG. 4, operation S130 may specifically include the following operations:

Operation S131: Perform semantic analysis on the translation result corresponding to the candidate live stream, to obtain a semantic analysis result corresponding to the translation result.

The semantic analysis result is configured for indicating whether a stable translation result exists in the translation result.

As an implementation, semantic analysis may be performed on the translation result corresponding to the candidate live stream (for example, translated subtitles in the translation result) based on a natural language processing (NLP) technology. For example, lexical-level semantic analysis and/or sentence-level semantic analysis may be performed on sentence content of the translated subtitles in the translation result, and whether a stable translation result exists in the translation result is determined based on contextual semantics of words, phrases, or short sentences in the sentence content.

Operation S132: Acquire an end time corresponding to the candidate live stream.

Specifically, if the translation result corresponding to the candidate live stream includes the end time corresponding to the candidate live stream, the end time corresponding to the candidate live stream is acquired from the translation result corresponding to the candidate live stream.

Operation S133: Acquire a target end timestamp of the to-be-pushed target live stream and a duration threshold preset for the target live stream, and take a sum of the target end timestamp and the duration threshold as a reference time.

Operation S134: Compare the end time corresponding to the candidate live stream with the reference time, to obtain a comparison result.

The duration threshold herein may be a preset threshold at which it is assumed that stable content can be acquired, and the duration threshold may be recorded as N or Tₜₕᵣ.

In this embodiment of this application, whether the end time corresponding to the candidate live stream is less than the reference time or equal to the reference time may be determined according to the comparison result obtained by comparison.

Operation S135: Determine, based on the comparison result, whether the end time corresponding to the candidate live stream is less than the reference time.

Operation S136: Determine, based on the semantic analysis result corresponding to the translation result, whether a stable translation result exists in the translation result.

Specifically, if the comparison result indicates that the end time corresponding to the candidate live stream is less than the reference time and the semantic analysis result indicates that a stable translation result exists in the translation result corresponding to the candidate live stream, operation S137 of taking the translation result corresponding to the candidate live stream as the to-be-pushed target translation result may be further performed.

Exemplarily, if the duration threshold Tₜₕᵣ=5 seconds and the target end timestamp of the to-be-pushed target live stream Tₛₜₐₘₚ=14:32.15, the reference time T_{ref}=Tₛₜₐₘₚ+Tₜₕᵣ=14:38.15. If the translation result corresponding to the candidate live stream includes a translation result (for example, the foregoing translated subtitles) of a statement expressed by an audio whose duration (for example, an audio duration of audio data collected in the foregoing sampling duration) is 3.23 seconds and the translation result (for example, the foregoing translated subtitles) of the statement expressed by the audio is a sentence, after semantic analysis is performed on the translation result (for example, the foregoing translated subtitles) of the statement expressed by the audio, the translation result (for example, the foregoing translated subtitles) may be determined as a stable translation result and an end time corresponding to the candidate live stream T_{end}=stamp+3.23 s=14:35.38, which does not exceed the reference time T_{ref}. Therefore, the translation result corresponding to the candidate live stream may be taken as the to-be-pushed target translation result.

In some embodiments, if the end time corresponding to the candidate live stream is less than the reference time and no stable translation result exists in the translation result corresponding to the candidate live stream, operation S138 of acquiring a new candidate live stream from the captured live streams based on the target timestamp is performed. Then, operation S120 is performed.

In operation S138, for the new candidate live stream acquired from the captured live stream based on the target timestamp, the new candidate live stream is still a live stream whose start time is the target timestamp and whose end time is an end time of a live stream most recently captured. A new live stream is captured in real time, when the target timestamp remains unchanged, compared with a previously acquired candidate live stream, a duration corresponding to a current newly acquired candidate live stream is longer, a duration of an audio stream in the current newly acquired candidate live stream is also longer, and the audio stream expresses more content. Therefore, in this way, there may be a higher probability that translation is performed based on the audio stream in the new candidate live stream having a longer duration to obtain a stable translation result. Based on the new candidate live stream acquired, translation processing is then correspondingly performed according to operation S120, and then operation S131 and subsequent operations are performed.

When the end time corresponding to the candidate live stream is less than the reference time and the semantic analysis result corresponding to the translation result of the candidate live stream indicates that no stable translation result exists, a possible reason for the absence of the stable translation result is that the duration corresponding to the candidate live stream is shorter and the audio stream in the candidate live stream does not completely present a sentence of the livestreamer. In this case, if the translation result of the candidate live stream is pushed to the viewer end with the target live stream, the translation result displayed at the viewer end may be inaccurate, and in a subsequent process, the translation result displayed in a live streaming picture may be modified multiple times. In this way, a translation result seen by the viewer is frequently modified, leading to poor live streaming viewing experience of the viewer and affecting a live streaming effect. Therefore, in this case, it is proposed in this embodiment of this application that when no stable translation result exists in the translation result corresponding to the candidate live stream, the translation result of the candidate live stream obtained by translation this time needs to be discarded, and a new candidate live stream is acquired from the captured live streams for translation. A duration corresponding to audio data in the new candidate live stream (that is, the candidate live stream acquired from the bitstream buffer pool this time) is longer than a duration corresponding to audio data in an old candidate live stream (that is, a candidate live stream acquired from the bitstream buffer pool last time), which means that, in this case, in a process of translating the audio data in the new candidate live stream (that is, the candidate live stream acquired from the bitstream buffer pool this time) by using the translator, the audio data in the old candidate live stream (that is, the candidate live stream acquired from the bitstream buffer pool last time) included therein and other newly acquired audio data may also be translated again by using the translator.

Specifically, when the end time corresponding to the candidate live stream is less than the reference time and the semantic analysis result corresponding to the translation result of the candidate live stream indicates that no stable translation result exists, considering that a possible reason for the absence of the stable translation result is that a duration corresponding to the candidate live stream is shorter, since newly generated live streams are always captured in the bitstream buffer pool in real time, in this case, a candidate live stream with a longer duration may be acquired from the live streams captured in the bitstream buffer pool. In this way, a new candidate live stream having a longer duration and configured for translation may be provided, and subsequently, after translation processing is performed on the new candidate live stream by using the translator, there may be a higher probability that a stable translation result is obtained. When the end time corresponding to the candidate live stream is less than the reference time and the semantic analysis result corresponding to the translation result of the candidate live stream indicates that no stable translation result exists, a new candidate live stream may be acquired for translation. Since the target translation result is not determined, the target translation result in this case is actually in a state of waiting to be pushed.

In some embodiments, a first interval duration between two adjacently acquired candidate live streams may be set. When the end time corresponding to the candidate live stream is less than the reference time and the semantic analysis result corresponding to the translation result indicates that no stable translation result exists, if an interval duration between a current time and previous acquisition of the candidate live stream reaches the first interval duration, a new candidate live stream is read from the buffer.

In this embodiment of this application, if it is determined, based on the comparison result, that the end time corresponding to the candidate live stream is no less than (for example, greater than or equal to) the reference time, operation S139 may be further performed to determine whether the end time corresponding to the candidate live stream is equal to the reference time.

Specifically, if yes, that is, if the end time corresponding to the candidate live stream is equal to the reference time, operation S137 of taking the translation result corresponding to the candidate live stream as the to-be-pushed target translation result may be further performed.

Exemplarily, if the duration threshold Tₜₕᵣ=5 seconds and the target end timestamp Tₛₜₐₘₚ=14:32.15, the reference time T_{ref}=Tₛₜₐₘₚ+Tₜₕᵣ=14:38.15. If the duration of the translation result corresponding to the candidate live stream has been 5 seconds, the end time corresponding to the candidate live stream T_{end}=stamp+5 s=14:35.15, equal to the reference time T_{ref}, and the translation result corresponding to the candidate live stream may be determined as the to-be-pushed target translation result. stamp refers to a start time of the candidate live stream, that is, the foregoing target timestamp.

In some embodiments, if the end time corresponding to the candidate live stream is equal to the reference time, for the target live stream, a delayed pushing duration thereof reaches the duration threshold (that is, Tₜₕᵣ=5 seconds), and if the target live stream continues to be pushed in a delayed manner, for the user, real-time performance of live streaming is significantly degraded. Therefore, when the end time corresponding to the candidate live stream is equal to the reference time, regardless of whether a stable translation result exists in the translation result corresponding to the candidate live stream, the translation result corresponding to the candidate live stream needs to be determined as the to-be-pushed target translation result, to push the target translation result with the target live stream, thereby preventing an excessively long live streaming delay in the live streaming scenario.

In the foregoing embodiment, a trade-off is made between ensuring real-time performance of live streaming and ensuring accuracy of the translation result. If the acquired translation result of the candidate live stream does not include the stable translation result and the end time of the candidate live stream is less than the reference time, a new candidate live stream having a longer duration may be acquired for translation, and the target live stream is pushed in a delayed manner. However, when the end time of the candidate live stream is equal to the reference time, regardless of whether the translation result of the candidate live stream includes the stable translation result, the translation result of the candidate live stream needs to be taken as the to-be-pushed target translation result, and the target translation result is pushed along with the target live stream. In this way, a duration during which the target live stream is delayed in being pushed at most is the duration threshold (for example, Tₜₕᵣ=5 seconds). In other words, in this embodiment of this application, to improve accuracy of live streaming translation, real-time performance of some live streaming may be properly sacrificed. In this way, frequent changes in a translation result at the viewer end caused by inaccuracy of the translation result due to an excessively short duration of an audio stream in a live stream can be prevented, and a situation in which a duration of an audio stream in a live stream is excessively long and a translation result of a candidate live stream within the reference time corresponding to the duration threshold (for example, the above Tₜₕᵣ=5 seconds) needs to be directly intercepted from a translation result of a candidate live stream with an excessively long duration within the preset duration threshold (for example, the above Tₜₕᵣ=5 seconds) as a target translation result finally pushed with the target live stream, to ensure that the target live stream and the target translation result in a live streaming process can ensure relative timeliness of live streaming within a particular delayed duration.

Further, the method further includes: when the semantic analysis result corresponding to the translation result of the candidate live stream indicates that a stable translation result exists in the translation result, operation S141 of storing the end time of the candidate live stream as a new target timestamp may be further performed. In this case, regardless of whether the end time corresponding to the candidate live stream is less than the reference time or is equal to the reference time, the end time of the candidate live stream may be stored as the new target timestamp.

In the foregoing embodiment, if the translation result of the candidate live stream includes the stable translation result, the end time of the candidate live stream may be taken as the new target timestamp, and a candidate live stream is acquired from the bitstream buffer pool again according to the new target timestamp next time. In this way, it can be ensured that before a stable translation result appears, an audio stream in the live stream in a time period from the target timestamp to the start time of the target live stream is configured for aided translation, so as to provide more data for translation, thereby ensuring accuracy of live streaming translation. In this embodiment of this application, when the translator considers that the translation result of the candidate live stream includes a stable translation result, determination may be further performed by using the controller, to finally determine that translated text content in the translation result of the candidate live stream that is obtained by translation by the translator is generally accurate. In this way, during subsequent processing, the controller may take the translation result of the candidate live stream as the foregoing stable translation result, and then may take the end time of the candidate live stream as a new target timestamp, to acquire a new candidate live stream for translation according to the new target timestamp (that is, the end time of the candidate live stream). In the process of acquiring the new candidate live stream for translation from the bitstream buffer pool according to the new target timestamp, the computer device (for example, the live streaming server) as referred to in this embodiment of this application may select, from the captured live streams by using the foregoing translation content selector, a live stream whose start time is the new target timestamp and whose end time is after the new target timestamp as the new candidate live stream. In other words, in this embodiment of this application, the new target timestamp may be skipped, and the live stream after the new target timestamp is selected for translation. In this way, a translation workload can be reduced, and a translation speed can be increased.

As an implementation, after the to-be-pushed target translation result is determined based on the translation result corresponding to the candidate live stream and the target end timestamp of the to-be-pushed target live stream, the end time of the candidate live stream may be taken as the new target timestamp.

When semantic analysis is performed on the translation result corresponding to the candidate live stream, a stable translation result in the translation result may be taken as a target translation result for pushing. In addition, when the end time corresponding to the candidate live stream is equal to the reference time, the translation result corresponding to the candidate live stream may be directly taken as the target translation result for pushing. In other words, in this embodiment of this application, a target translation result can be acquired for pushing within a corresponding time period (that is, the time period from the target timestamp to the reference time) within each duration threshold (for example, the foregoing Tₜₕᵣ=5 seconds). For example, it is assumed that the duration threshold is 5 seconds, and a 10-second candidate live stream includes a sentence. When the candidate live stream is translated to the 5^{th} second, complete semantics is still unknown. That is, within a time period corresponding to the duration threshold of 5 seconds, although a stable translation result cannot be obtained, the first 5 seconds of the translation still has certain semantics. To this end, a translation result of the first 5 seconds may be taken as a target translation result for pushing, and then translation is continued for the remaining live stream, to prevent sudden viewing of a long translation result by the viewer after waiting for a longer time. In addition, since the stable translation result is a translation result in a steady state, it may be ensured that a translation result of live streaming translation has higher accuracy. In this way, an excessively long translation waiting duration caused by long-time translation of a complete sentence can be effectively prevented. In this case, accuracy of live streaming translation can be ensured, and relative real-time performance of live streaming translation can also be improved to some extent.

In the foregoing embodiment, when the end time corresponding to the candidate live stream is equal to the reference time and the translation result corresponding to the candidate live stream does not include the stable translation result, the translation result corresponding to the candidate live stream may still be determined as the to-be-pushed target translation result. In this case, the target timestamp is not updated. In this case, the candidate live stream is acquired next time still according to the target timestamp based on which the candidate live stream is acquired last time. In this way, compared with the previously acquired candidate live stream, the newly acquired candidate live stream has a longer duration, and start times thereof are both the target timestamp. In this way, if a translation result in a translation result corresponding to a candidate live stream that has been pushed is inaccurate, a relatively accurate translation result may be obtained by performing translation based on the newly acquired candidate live stream having the longer duration. In this way, an inaccurate translation result previously pushed may be covered with a relatively accurate translation result. Therefore, for an inaccurate translation result from previous translation, a new accurate translation result may be transmitted to the viewer, and the old translation result may be replaced with the new translation result. For example, assuming that the duration threshold is 5 seconds, if no stable translation result exists in the translation result of the candidate live stream obtained by translation within a translation duration (for example, the foregoing reference time) corresponding to the 5 seconds, but since the end time of the candidate live stream is currently equal to the reference time calculated when the duration threshold is 5 seconds, the translation result of the candidate live stream obtained by translation currently needs to be taken as the target translation result for periodic pushing. In this way, when a new candidate live stream with a longer duration (for example, 10 s) is acquired from the live streams captured in the bitstream buffer pool based on a same target timestamp, the currently acquired new candidate live stream may be translated, to replace an old translation result obtained from previous translation with a translation result of the new candidate live stream with the longer duration (for example, 10 s) and is obtained by translation, so that the new accurate translation result can be transmitted to the viewer.

In some embodiments, when the end time corresponding to the candidate live stream is equal to the reference time and the translation result corresponding to the candidate live stream does not include the stable translation result, the translation result corresponding to the candidate live stream may still be determined as the to-be-pushed target translation result. In other words, in this embodiment of this application, when the end time corresponding to the candidate live stream is equal to the reference time, an old translation result (that is, a currently obtained translation result corresponding to the candidate live stream) may be first periodically transmitted to the viewer, to be presented on the screen of the viewer in real time. Subsequently, a new candidate live stream with a longer duration may be acquired from the captured live streams based on the target timestamp for translation, and then the old translation result may be corrected according to a new translation result most recently obtained. For example, displayed text (i.e., old translated subtitles) may be corrected by using text in the new translation result. In addition, in this embodiment of this application, when a new translation result is obtained and a stable translation result exists in the new translation result, while the new translation result is pushed to the viewer end for display, voice content of the livestreamer may also be displayed together with the new translation result by using recognized speech recognition content.

In some embodiments, whether a stable translation result exists in the translation result corresponding to the candidate live stream may alternatively be determined with reference to the speech recognition content corresponding to the candidate live stream and the translation result corresponding to the candidate live stream. Specifically, semantic analysis may be performed on the speech recognition content corresponding to the candidate live stream, to obtain a first semantic analysis result. The first semantic analysis result is configured for indicating whether the speech recognition content corresponding to the candidate live stream is a complete statement. If the speech recognition content corresponding to the candidate live stream is a complete statement, it may be determined that there is a higher probability that a stable translation result exists in the translation result corresponding to the candidate live stream. Otherwise, if the speech recognition content corresponding to the candidate live stream is not a complete statement, there is a lower probability that a stable translation result exists in the translation result corresponding to the candidate live stream. Based on the principle, when the first semantic analysis result indicates that the speech recognition content corresponding to the candidate live stream is a complete statement, semantic analysis may be further performed on the translation result corresponding to the candidate live stream, to determine whether a stable translation result exists in the translation result. On the contrary, if the first semantic analysis result indicates that the speech recognition content corresponding to the candidate live stream is not a complete statement, operation 138 may be performed, that is, a new candidate live stream may be acquired from the captured live streams based on the target timestamp for translation.

In the network live streaming scenario, accuracy and real-time performance of live streaming translation are mutually exclusive. For example, if a duration of a live stream for translation is longer, accuracy of the translation is higher. Correspondingly, if a waiting duration for acquiring a to-be-translated live stream is longer, real-time performance of live streaming translation is lower. In this application, a duration threshold is set, that is, the duration threshold is a maximum delayed pushing duration of the target live stream. In other words, the duration threshold may be configured for representing the maximum delayed pushing duration of the target live stream in the process of obtaining the target translation result. This means that within the maximum delayed pushing duration, timeliness and reliability of target translated content obtained in the live streaming translation process can still be ensured. Therefore, magnitude of the duration threshold may reflect levels of real-time performance of the live streaming.

The magnitude of the duration threshold may be set according to a requirement for real-time performance of the live streaming. For a live streaming scenario in which the livestreamer and the viewer need to interact, there is a higher requirement for real-time performance of the live streaming. In this case, a smaller duration threshold may be set, to prevent an excessively long delayed pushing duration for the target live stream. However, for a live streaming scenario in which there is little or even no interaction between the livestreamer and the viewer, there is a relatively low requirement for real-time performance of the live streaming, and a larger duration threshold may be set, to fully ensure accuracy of a target translation result pushed to the viewer end.

In some embodiments, scenario application information may be acquired. The scenario application information indicates a target live streaming interaction level. The target live streaming interaction level is a live streaming interaction level of a current live streaming scenario (or a current target live streaming room). The target live streaming interaction level may be preset by a user (for example, by a user as a livestreamer). Subsequently, based on a correspondence between live streaming interaction levels and durations, a duration corresponding to the target live streaming interaction level is determined as the duration threshold.

The target live streaming interaction level is a quantized representation of a requirement for real-time performance of the current live streaming scenario. The scenario application information is information that can reflect the requirement for real-time performance of the current live streaming scenario. The correspondence between live streaming interaction levels and durations may be pre-stored in a relational database. In some embodiments, the scenario application information may be pre-specified by a user on a terminal. For example, the livestreamer end may transmit a value of a requirement for real-time performance of live streaming translation that is directly set by the livestreamer to the server as the scenario application information. Alternatively, the scenario application information may be information acquired by the server from the livestreamer end and indicating a volume of viewer interaction, for example, a danmu transmission rate, and then the duration threshold is determined based on the danmu transmission rate. A higher transmission rate indicates more interaction, and a higher requirement for real-time performance of live streaming translation indicates that the duration threshold may be smaller.

In some other embodiments, a duration of interaction data of a target viewer may be predicted by using a duration prediction model, to obtain a corresponding duration threshold. The duration prediction model may be obtained by performing supervised learning on a preset classification network based on sample interaction data and a label duration threshold. The interaction data is data of the viewer participating in live streaming interaction when viewing live streaming, and may include an average danmu transmission rate or an average like rate when the viewer participates in different live streaming, which is not limited herein. In some embodiments, for different sample interaction data in a training set, corresponding label duration thresholds (Ground Truth) may be pre-calculated based on experiments. The preset classification network may be a deep neural network, for example, a combination of an embedding layer and a multilayer perceptron (MLP).

Specifically, a duration of the sample interaction data is predicted by using the duration prediction model, to obtain a predicted duration threshold, and a target loss is calculated based on the predicted duration threshold and the label duration threshold corresponding to the sample interaction data. Further, iterative supervised learning training is performed on the preset classification network based on the target loss until the preset classification network meets a training ending condition, to obtain a duration prediction model. In this way, personalized duration prediction may be performed for the target viewer by using the duration prediction model, to obtain a time threshold matching a delay tolerance degree of the target viewer, so that a target translation result pushed to the viewer end is more accurate, and real-time performance of display of the target translation result better meets a personalized requirement of the viewer.

In some other embodiments, a duration threshold setting component may be displayed at the viewer end, so that when viewing live streaming, the viewer may set time thresholds of different durations according to actual experience requirements on viewing of live streaming. For example, a duration threshold setting key is displayed on a live streaming interface of the viewer end. When the viewer clicks the setting key, a slide bar configured for adjusting magnitude of the duration threshold is displayed, and the viewer may adjust, by sliding the slide bar, the duration threshold required by the viewer when viewing live streaming. In this way, the viewer directly sets the duration threshold, so that real-time performance of display of the target translation result can better meet a current viewing requirement of the viewer, the target translation result pushed to the viewer end is more accurate for the target viewer, and efficiency of adjustment on real-time performance and accuracy of live streaming translation is also improved.

Operation S140: Re-encode the to-be-pushed target live stream based on the target translation result, to obtain a re-encoded live stream.

In this embodiment of this application, when translation processing is performed on the candidate live stream, since the candidate live stream has been decoded in advance, other decoding information such as corresponding audio and video data can be quickly acquired. Therefore, after the target translation result obtained by translation is added to the audio and video data, the audio and video data with the translation result is obtained. To this end, the audio and video data with the translation result may be encoded again, to obtain a new audio and video stream (that is, a new audio and video bitstream, or the foregoing re-encoded live stream) by encoding, to facilitate pushing.

As an implementation, the target translation result may be added, as custom data of a frame (that is, an auxiliary enhanced frame) corresponding to SEI, to the auxiliary enhanced frame. Further, the auxiliary enhanced frame may be inserted before an I frame or a P frame in a video stream of the to-be-pushed target live stream, and then be encoded together with the target live stream into a new audio and video stream, that is, the re-encoded live stream.

Operation S150: Push the re-encoded live stream, to display the target translation result at a viewer end.

Since the re-encoded live stream includes the video stream in the target live stream, the audio stream in the target live stream, and the target translation result, after the re-encoded live stream is pushed to the viewer end, the viewer end may display a picture based on the video stream in the target live stream, and display translated text content in the target translation result on a live streaming picture as subtitles (for example, the foregoing translated subtitles), and synchronously play back the corresponding audio stream while playing back the video stream.

In some embodiments, the target translation result may further include speech recognition content corresponding to the live stream. In this way, both the speech recognition content and the translation result may be displayed on the live streaming picture as subtitles at the viewer end.

In some embodiments, since delayed pushing durations of different target live streams may vary, after a re-encoded live stream is obtained by re-encoding, if the re-encoded live stream is directly pushed, there may be a case in which pushing is not continuous, that is, there may be some time periods during which there is no re-encoded live stream available for pushing. For example, taking a candidate live stream with a duration of 30 seconds as an example, if a stable translation result is obtained by translation in the first 3 seconds and is inserted into an audio and video stream, it is assumed subsequently that another stable translation result can be obtained only until an end time of the candidate live stream.

Assuming that the re-encoded live stream corresponding to the stable translation result is transmitted to the viewer end, in a period of time after the re-encoded live stream of the stable translation result in the first 3 seconds is transmitted, no live stream of any translation result may be transmitted. This may cause frame freezing at the viewer end, affecting viewing of live streaming by the viewer. To this end, in some embodiments of this application, the re-encoded live stream may be captured and then pushed.

As an implementation, if a time difference between a current time and an end time corresponding to the re-encoded live stream reaches a duration threshold, the target live stream is pushed. Specifically, the target live stream may be stored to a re-encoding buffer pool. If the time difference between the current time and the end time corresponding to the re-encoded live stream reaches the duration threshold, the audio and video stream stored in the re-encoding buffer pool may be pushed to the viewer end in real time. The end time corresponding to the re-encoded live stream is an end time of the target live stream corresponding to the re-encoded live stream. In this embodiment, it can be ensured that pushing is performed when a re-encoded live stream with a particular duration is captured, thereby ensuring continuity and stability of pushing.

For example, taking a candidate live stream with a duration of 30 seconds as an example, in the case of a re-encoded live stream of a stable translation result of the first 3 seconds, the re-encoded live stream is stored to the re-encoding buffer pool, and the re-encoded live stream continues to be accumulated in the re-encoding buffer pool until a time difference between a current time and an end time corresponding to the re-encoded live stream reaches a duration threshold, that is, at least a live stream with a duration corresponding to the duration threshold (that is, an entire encoding duration, for example, the duration of 30 seconds herein) is accumulated in the re-encoding buffer pool, and the live stream stored in the re-encoding buffer pool is pushed to the viewer end in real time.

In this way, it is set that a periodical translation result needs to be given in a particular duration (that is, the duration threshold is reached), and then delayed transmission with a duration (that is, the duration threshold is reached) is set, to ensure that a new re-encoded live stream is always added to the re-encoding buffer pool in real time, so as to achieve continuous pushing, thereby preventing frame freezing of the live streaming picture at the viewer end caused by discontinuity of pushing.

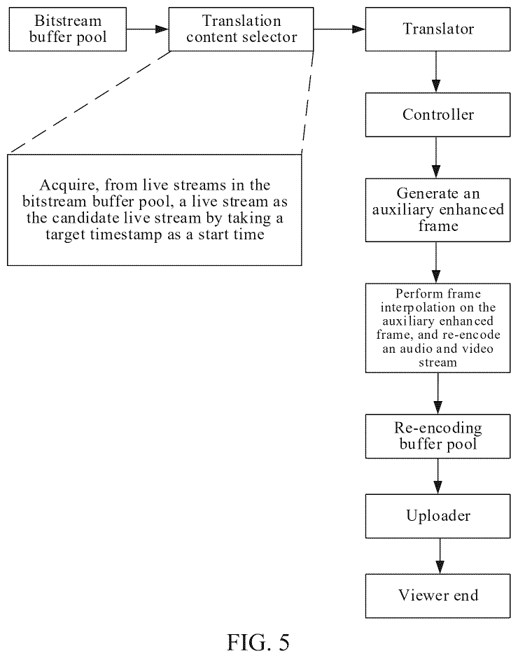

Exemplarily, referring to FIG. 5, FIG. 5 is a flowchart of a translation process according to an embodiment of this application. As shown in FIG. 5, a live streaming translation process may include a bitstream buffer pool, a translation content selector, a translator, a controller, an uploader, and a re-encoding buffer pool. The bitstream buffer pool may be configured to cache live streams pushed by a livestreamer end. For example, if the bitstream buffer pool is deployed on the live streaming server, after the livestreamer end pushes a live stream obtained by real-time encoding to a backend (that is, the live streaming server), the live streaming server may add the received live stream to the bitstream buffer pool, so that live streams continuously pushed by the livestreamer end may be continuously captured by using the bitstream buffer pool. The translation content selector may be configured to quickly select, from the live streams captured in the bitstream buffer pool by using the target timestamp, a live stream that currently needs to be translated as a to-be-translated candidate live stream. Further, as shown in FIG. 5, the translator may be configured to perform translation processing on the candidate live stream. Then, the controller may be configured to determine a to-be-pushed target translation result. Finally, a re-encoded live stream waiting to be pushed to the viewer end may be captured in the re-encoding buffer pool. The re-encoded live stream is a live stream that carries the target translation result and is obtained by re-encoding.

Specifically, as an implementation, when the livestreamer initiates live streaming, the livestreamer end may collect audio and video data in real time, perform audio and video coding (that is, the foregoing audio coding and video coding) on the audio and video data collected in real time, to obtain an audio and video bitstream (that is, the foregoing live stream) corresponding to the audio and video data, and then may push the audio and video bitstream (that is, the foregoing live stream) obtained by encoding to the live streaming server, and further, the live streaming server may cache the received encoded live stream to the bitstream buffer pool. Further, the live streaming server may acquire, from the bitstream buffer pool by using the translation content selector and by using the target timestamp (that is, the end time of the live stream corresponding to the previous stable translation result) as a start time, a live stream (that is, a live stream whose start time is the target timestamp and whose end time is after the target timestamp) as the to-be-translated candidate live stream. Further, the live streaming server may perform translation processing on speech recognition content corresponding to the candidate live stream by using the translator, to output a translation result corresponding to the candidate live stream.

Further, the live streaming server may perform semantic analysis on the translation result corresponding to the candidate live stream by using the controller, and further determine, based on a semantic analysis result, whether a stable translation result exists in the translation result corresponding to the candidate live stream or whether an end time corresponding to the candidate live stream is equal to a reference time. If the end time corresponding to the candidate live stream does not exceed (for example, is less than) the reference time and the semantic analysis result corresponding to the translation result indicates that a stable translation result exists, the translation result corresponding to the candidate live stream is taken as the to-be-pushed target translation result. In some embodiments, if the end time corresponding to the candidate live stream is equal to the reference time, regardless of whether a stable translation result exists in the translation result corresponding to the candidate live stream, the translation result corresponding to the candidate live stream needs to be determined as the to-be-pushed target translation result. In some embodiments, if the end time corresponding to the candidate live stream is less than the reference time and the semantic analysis result corresponding to the translation result indicates that no stable translation result exists, the controller needs to instruct the translation content selector to continue to acquire a new candidate live stream (that is, a to-be-translated live stream acquired from the bitstream buffer pool next time, for example, a next candidate live stream) from captured live streams based on the target timestamp, to continue the operation of performing translation processing on the new candidate live stream. In this embodiment of this application, the specific process of performing translation processing on the new candidate live stream to obtain a new translation result may be obtained with reference to the description of the specific process of performing translation processing on the candidate live stream. Details are not described herein again.

Further, the live streaming server may re-encode the to-be-pushed target live stream based on the target translation result, to obtain a re-encoded live stream. Specifically, as shown in FIG. 5, when determining the to-be-pushed target translation result by using the controller, the live streaming server may generate a corresponding auxiliary enhanced frame based on the target translation result, and perform frame interpolation on the auxiliary enhanced frame. For example, the auxiliary enhanced frame may be inserted into video data of a video stream of the to-be-pushed target live stream (for example, in a re-encoding process, the auxiliary enhanced frame may be first inserted before an I frame and/or a P frame in the video stream) and then hybrid coding (that is, the foregoing audio and video coding) is performed thereon again with audio data in an audio stream of the target live stream, to obtain a re-encoded live stream by hybrid coding (that is, the foregoing live stream carrying the target translation result may be obtained by re-encoding). Further, the live streaming server may cache the re-encoded live stream to the re-encoding buffer pool.

In this embodiment of this application, the live streaming server may generate an auxiliary enhanced frame based on the target translation result, which is a custom data field that adds the target translation result to SEI and is encapsulated into a NALU of a particular type. In addition, re-encoding as referred to in this embodiment of this application means decoding an original bitstream (that is, a to-be-pushed live stream), to obtain video data and audio data in the live stream by decoding, and encoding is performed according to a new encoding rule and an encoding parameter, to generate a new bitstream, and then the new bitstream may be referred to as a re-encoded live stream. The new encoding rule herein mainly means that, during the re-encoding, an I frame and/or a P frame obtained by encoding occurring in video data obtained by decoding may be monitored, and a SEI frame (that is, the foregoing auxiliary enhanced frame) obtained by construction by using the foregoing SEI content is inserted before the I frame/P frame. The foregoing SEI content is content generated when the foregoing target translation result is added to a custom data field in a SEI data format.

Further, the live streaming server may upload the re-encoded live stream in the re-encoding buffer pool to the CDN by using the uploader when determining that a duration of the re-encoded live stream in the re-encoding buffer pool is no less than the duration threshold, and then the viewer end may pull a stream from the CDN to obtain the re-encoded live stream, so that the re-encoded live stream may be further decoded and played back subsequently.

In this embodiment, a to-be-translated candidate live stream may be acquired from captured live streams. The candidate live stream is a live stream whose start time is a target timestamp and whose end time is after the target timestamp. The target timestamp is an end time of a live stream corresponding to a previous stable translation result. In this embodiment of this application, the live stream corresponding to the previous stable translation result is a translated live stream, the translated live stream is a previous live stream of the candidate live stream, and the previous stable translation result is a stable translation result obtained after translation processing is performed on the translated live stream. Further, in this embodiment of this application, translation processing may be performed on speech recognition content corresponding to the candidate live stream, to obtain a translation result corresponding to the candidate live stream, and a to-be-pushed target translation result is determined based on the translation result corresponding to the candidate live stream and a target end timestamp of the to-be-pushed target live stream. The to-be-pushed target translation result is a translation result that is to be pushed with the target live stream, and a time difference between an end time of a live stream corresponding to the target translation result and the target end timestamp does not exceed a duration threshold. Further, in this embodiment of this application, the to-be-pushed target live stream may be re-encoded based on the target translation result, to obtain a re-encoded live stream, and the re-encoded live stream is pushed, to display the target translation result at the viewer end (for example, specifically, translated text content in the target translation result, that is, the foregoing translated subtitles, may be displayed). Therefore, in this embodiment of this application, on a condition that the time difference between the end time of the live stream corresponding to the target translation result and the target end timestamp does not exceed the duration threshold, it may be determined, based on the translation result corresponding to the candidate live stream within a fixed duration (that is, does not exceed a reference duration corresponding to the duration threshold), that the to-be-pushed target translation result is first pushed, thereby preventing an excessively long translation waiting duration caused by long-time translation of a complete sentence and improving real-time performance of live streaming translation. Therefore, the translation result and a video picture in which a speaker is located can be synchronously displayed.

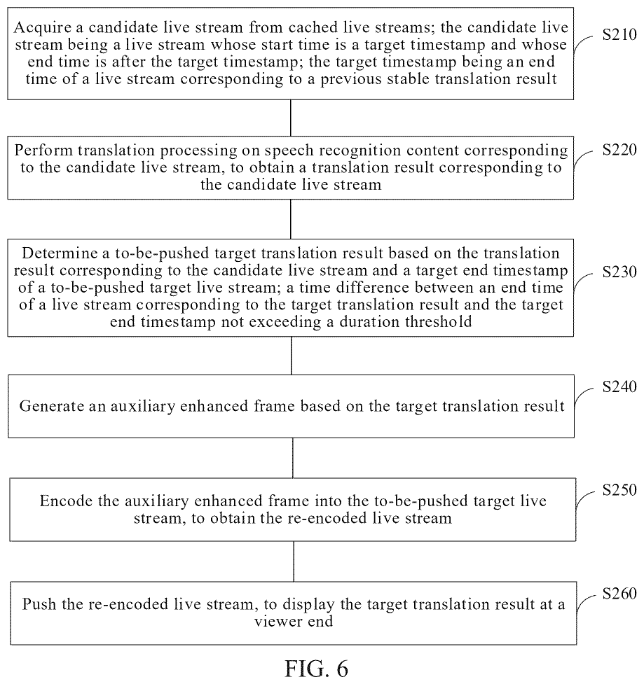

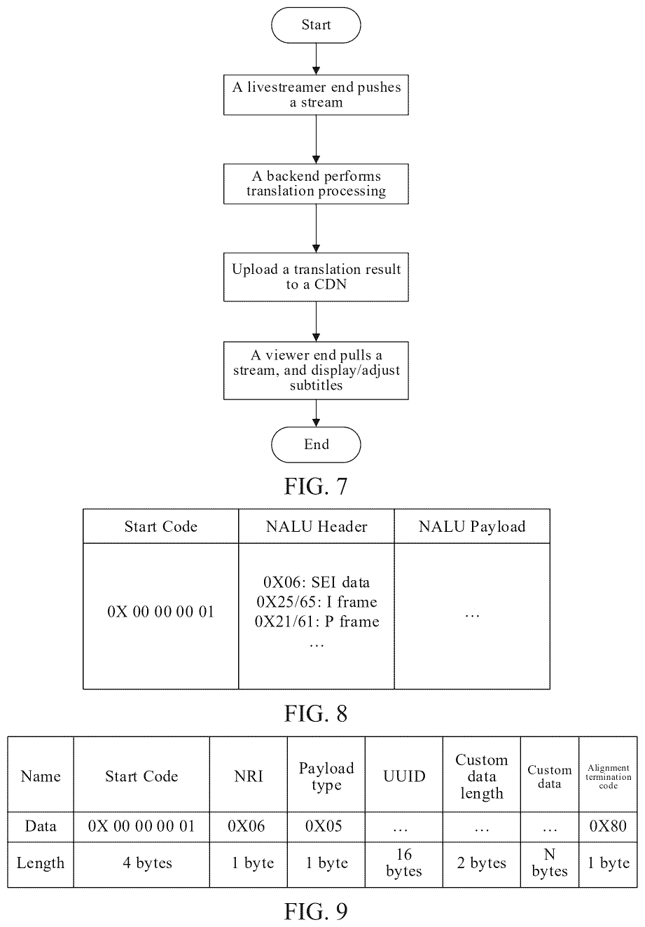

Referring to FIG. 6, FIG. 6 is a schematic flowchart of a live streaming translation method according to another embodiment of this application. In this embodiment, the live streaming translation method may be performed by a live streaming server corresponding to a live streaming service provider. The live streaming translation method shown in FIG. 6 may be applied to a live streaming translation procedure as shown in FIG. 7. Further, referring to FIG. 7, FIG. 7 is a flowchart of live streaming translation according to an embodiment of this application. Specifically, the live streaming translation procedure shown in FIG. 7 includes the following content: a livestreamer end pushes a stream to a backend (that is, the foregoing live streaming server), then the backend (that is, the foregoing live streaming server) performs translation processing on a currently acquired candidate live stream according to the live streaming translation method shown in FIG. 6, the live streaming server uploads a translated bitstream carrying translated subtitles (that is, the foregoing re-encoded live stream) to a CDN, then, a viewer end may pull a stream from the CDN to the re-encoded live stream and acquire an audio and video (that is, the foregoing audio and video data) and translated subtitles (that is, the foregoing translated text content) after decoding the re-encoded live stream, and then the translated subtitles may also be displayed on a screen while the audio and video (that is, the audio and video data) is played back. In addition, the viewer end may also adjust the translated subtitles. Specifically, as shown in FIG. 6, the live streaming translation method may include the following operation S210 to operation S260:

Operation S210: Acquire a to-be-translated candidate live stream from captured live streams; the candidate live stream being a live stream whose start time is a target timestamp and whose end time is after the target timestamp; the target timestamp being an end time of a live stream corresponding to a previous stable translation result, the live stream corresponding to the previous stable translation result being a translated live stream, the translated live stream being a previous live stream of the candidate live stream, and the previous stable translation result being a stable translation result obtained after translation processing is performed on the translated live stream.

Operation S220: Perform translation processing on speech recognition content corresponding to the candidate live stream, to obtain a translation result corresponding to the candidate live stream.

Operation S230: Determine a to-be-pushed target translation result based on the translation result corresponding to the candidate live stream and a target end timestamp of a to-be-pushed target live stream; the to-be-pushed target translation result being a translation result that is to be pushed with the target live stream, and a time difference between an end time of a live stream corresponding to the target translation result and the target end timestamp not exceeding a preset duration threshold, the duration threshold being a positive number, and the duration threshold being configured for representing a maximum delayed pushing duration of the target live stream.

Specifically, specific implementations of operation S210 to operation S230 may be obtained with reference to the descriptions of operation S110 to operation S130 in the foregoing embodiment, and details are not described herein again.

Operation S240: Generate an auxiliary enhanced frame based on the target translation result.

The auxiliary enhanced frame is a SEI frame. The SEI frame is a NALU in an audio and video coding bitstream that encapsulates auxiliary information into a specific type, and is also a data unit satisfying network transmission in video coding. For example, in an H.264 bitstream, images are organized in units of sequences, and one sequence includes a plurality of frames of images (that is, the plurality of collected video frame pictures). In this embodiment of this application, by taking a sequence as a unit, the corresponding sequence may be encoded to obtain an encoded data stream for pushing (for example, in the network live streaming scenario, a live stream may be obtained). During the encoding, a live stream corresponding to a sequence starts with an I frame and ends with a next I frame. One frame of image (that is, one video frame picture) may be divided into one or more slices. A slice includes macroblocks. The macroblocks are basic units of encoding processing. After being encoded, the slice may be packed into a NALU. That is, one frame of image corresponds to one NALU.

Referring to FIG. 8, FIG. 8 is a schematic diagram of a bitstream format of a NAL data unit according to an embodiment of this application. As shown in FIG. 8, the NAL data unit includes a start code, a NALU header, and a NALU payload. The start code is configured for separating two adjacent NAL data units (that is, two adjacent NALUs), and the start code may be “0X 00 00 00 01” represented in hexadecimal or “00 00 01” represented in binary.

The NALU header is configured for indicating a type of data therein (that is, the NAL data unit) and other information.

For example, if the NALU header is 0X06, the NALU payload may be filled in according to a data format requirement of SEI coding. The NALU header occupies 1 byte. Detection of a sequence parameter set (SPS), a picture parameter set (PPS), and an I/P/B frame in H.264 is implemented by using a NALU type in the NALU header. The NALU type may include a data type of 0X06SEI for data (for example, SEI data), a data type of 0X25/65 for data (for example, an I frame), and a data type of 0X21/61 for data (for example, a P frame) that are shown in FIG. 8.

As an implementation, a custom data field corresponding to the SEI may be determined based on a data coding format (that is, the NAL data unit), and then the target translation result may be added to the custom data field, to obtain an auxiliary enhanced frame. For example, referring to FIG. 9, FIG. 9 is a schematic diagram of a data format of SEI according to an embodiment of this application.

As shown in FIG. 8, that header data (NRI) of the SEI is 0X06 and the payload type is 0X05 indicates compliance with an H264 standard format, UUID is a service-defined identification code, a custom data length is calculated from custom data, the custom data adopts a type format defined by a service provider, with 0X80 padded at the end for alignment (i.e., alignment termination code is 0X80). Based on this, in this embodiment of this application, the target translation result may be added to a field of custom data in a SEI data format, to perform encoding to obtain the auxiliary enhanced frame. Further, after pulling, the viewer end may perform decoding according to the data format of the SEI, to obtain, from the field corresponding to the custom data obtained by decoding (that is, the custom data field), the translated subtitles in the target translation result for display.

As another implementation, in this embodiment of this application, speech recognition content of the live stream corresponding to the target translation result may be acquired, and then the speech recognition content and the target translation result may be added to the field corresponding to the custom data (that is, the custom data field), to obtain the auxiliary enhanced frame. In this way, after stream pulling, the viewer end may perform decoding according to the data format of the SEI, to obtain a translation result and speech recognition content corresponding to a live stream thereof, and display bilingual subtitles.

Operation S250: Encode the auxiliary enhanced frame into the to-be-pushed target live stream, to obtain the re-encoded live stream.

As an implementation, in this embodiment of this application, the to-be-pushed target live stream may be decoded, to acquire audio data of an audio stream and video data of a video stream in the to-be-pushed target live stream, and insert the auxiliary enhanced frame before a specified video frame (e.g., the foregoing I frame and/or P frame) in the video data of the video stream, to obtain reference video data. Further, in this embodiment of this application, the audio data of the audio stream and the reference video data may be re-encoded, to obtain the re-encoded live stream.

The specified video frame is a key frame (I frame) or a forward predictive coded frame (P frame) in the video data of the video stream. Considering requirements stipulated in a coding protocol, the auxiliary enhanced frame may be inserted into a preceding position of the I frame/P frame during the encoding, without affecting a decoding order of the re-encoded live stream.

Operation S260: Push the re-encoded live stream, to display the target translation result at a viewer end.

As an implementation, when pushing the re-encoded live stream, the live streaming server may send a translation adjustment instruction to the viewer end if determining that there is a translation result that needs to be adjusted. The translation adjustment instruction is configured for controlling the viewer end to adjust a previously transmitted re-encoded live stream based on a newly transmitted re-encoded live stream. For example, for a candidate live stream, an i^{th} translation result in the first 10 s thereof is I{X₁X₃}, and an i+1^{th} translation result is II{X₁X₂X₃X₄X₅}. To this end, a translation adjustment instruction needs to be generated, and the translation adjustment instruction is transmitted to the viewer end, so that the viewer end replaces X₃ at the second position in the translation result I{X₁X₃} with X₂X₃, and supplements X₄X₅ after X₃.

In this way, a translated translation result may be re-adjusted, which can improve real-time performance of live streaming translation and can also improve accuracy of the translation result. Specifically, a specific implementation of operation S260 may be obtained with reference to the description of operation S150 in the foregoing embodiment. Details are not described herein again.

In this embodiment, a to-be-translated candidate live stream may be acquired from captured live streams, where the candidate live stream is a live stream whose start time is a target timestamp and whose end time is after the target timestamp; and the target timestamp is an end time of a live stream corresponding to a previous stable translation result. In addition, in this embodiment of this application, translation processing may be performed on speech recognition content corresponding to the candidate live stream, to obtain a translation result corresponding to the candidate live stream, and then a to-be-pushed target translation result may be determined based on the translation result corresponding to the candidate live stream and a target end timestamp of the to-be-pushed target live stream. A time difference between an end time of a live stream corresponding to the target translation result and the target end timestamp does not exceed a duration threshold.

Further, in this embodiment of this application, an auxiliary enhanced frame may be generated based on the target translation result, which may specifically include, for example, determining, based on a data coding format, a custom data field (that is, the field of the custom data) corresponding to SEI, and adding the target translation result to the custom data field, to obtain the auxiliary enhanced frame. Then, the auxiliary enhanced frame is encoded into a to-be-pushed target live stream, to obtain a re-encoded live stream, and the re-encoded live stream is pushed, to display translated subtitles in the target translation result at a viewer end. In other words, in this embodiment of this application, on a condition that the time difference between the end time of the live stream corresponding to the target translation result and the target end timestamp does not exceed the duration threshold, it may be determined, based on the translation result corresponding to the candidate live stream within a fixed duration (that is, the foregoing reference time), that the to-be-pushed target translation result is first pushed, to improve real-time performance of live streaming translation. In addition, in this embodiment of this application, the auxiliary enhanced frame may further be inserted at a preceding position of a key frame or a forward predictive coded frame during the encoding, so as to prevent an influence of the viewer end on an order of decoding the audio and video stream. In this way, synchronous display of a translation result and a video picture can be ensured.

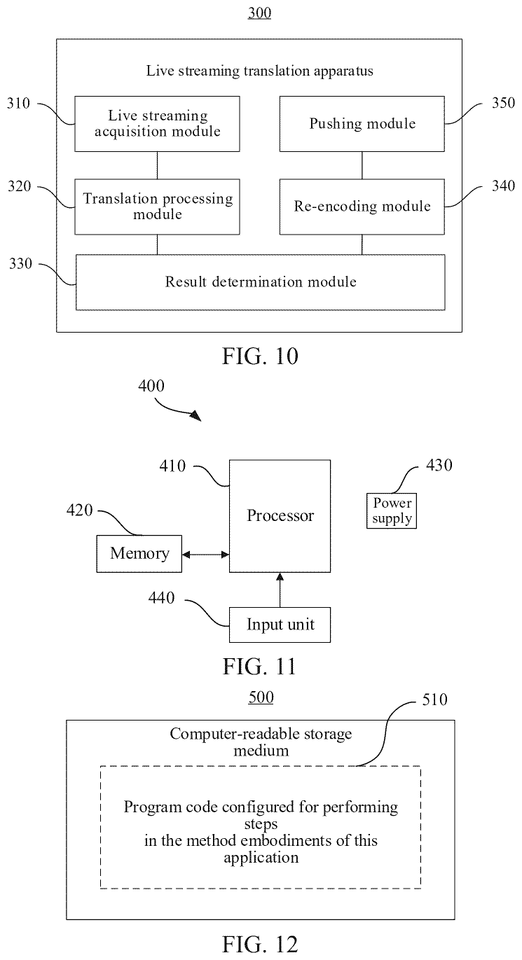

Referring to FIG. 10, FIG. 10 is a block diagram of modules of a live streaming translation apparatus according to an embodiment of this application. The live streaming translation apparatus 300 include: a live stream acquisition module 310, configured to acquire a to-be-translated candidate live stream from captured live streams; the candidate live stream being a live stream whose start time is a target timestamp and whose end time is after the target timestamp, the target timestamp being an end time of a live stream corresponding to a previous stable translation result, the live stream corresponding to the previous stable translation result being a translated live stream, the translated live stream being a previous live stream of the candidate live stream, and the previous stable translation result being a stable translation result obtained after translation processing is performed on the translated live stream; a translation processing module 320, configured to perform translation processing on speech recognition content corresponding to the candidate live stream, to obtain a translation result corresponding to the candidate live stream; a result determination module 330, configured to determine a to-be-pushed target translation result based on the translation result corresponding to the candidate live stream and a target end timestamp of a to-be-pushed target live stream; the to-be-pushed target translation result being a translation result that is to be pushed with the target live stream, and a time difference between an end time of a live stream corresponding to the target translation result and the target end timestamp not exceeding a preset duration threshold, the duration threshold being a positive number, and the duration threshold being configured for representing a maximum delayed pushing duration of the target live stream; a re-encoding module 340, configured to re-encode the to-be-pushed target live stream based on the target translation result, to obtain a re-encoded live stream; and a pushing module 350, configured to push the re-encoded live stream, to display the target translation result at a viewer end.

In some embodiments, the result determination module 330 may include a semantic analysis unit and a first determination unit. The semantic analysis unit is configured to perform semantic analysis on the translation result corresponding to the candidate live stream, to obtain a semantic analysis result corresponding to the translation result; the semantic analysis result being configured for indicating whether a stable translation result exists in the translation result. The first determination unit is configured to acquire an end time corresponding to the candidate live stream, acquiring a target end timestamp of the to-be-pushed target live stream and a duration threshold preset for the target live stream, take a sum of the target end timestamp and the duration threshold as a reference time, and compare the end time corresponding to the candidate live stream with the reference time, to obtain a comparison result. The comparison result is configured for determining whether the end time corresponding to the candidate live stream is less than the reference time. In this way, the first determination unit is further configured to take the translation result corresponding to the candidate live stream as the to-be-pushed target translation result if the comparison result indicates that the end time corresponding to the candidate live stream is less than the reference time and the semantic analysis result corresponding to the translation result indicates that a stable translation result exists in the translation result.

In some embodiments, the result determination module 330 may further include a second determination unit. The second determination unit is configured to determine the translation result corresponding to the candidate live stream as the to-be-pushed target translation result if the end time corresponding to the candidate live stream is equal to the reference time.

In some embodiments, the result determination module 330 may further include a return execution unit. The return execution unit is configured to acquire a new candidate live stream from the captured live streams based on the target timestamp if the end time corresponding to the candidate live stream is less than the reference time and the semantic analysis result corresponding to the translation result indicates that no stable translation result exists, and return to the operation of performing translation processing on speech recognition content corresponding to the candidate live stream, to obtain a translation result corresponding to the candidate live stream.

In some embodiments, the result determination module 330 may further include a timestamp determination unit. The timestamp determination unit is configured to store the end time of the candidate live stream as a new target timestamp.

In some embodiments, the re-encoding module 340 may include an enhanced frame generation unit and a re-encoding unit. The enhanced frame generation unit is configured to generate an auxiliary enhanced frame based on the target translation result. The re-encoding unit is configured to encode the auxiliary enhanced frame into the to-be-pushed target live stream, to obtain the re-encoded live stream.

In some embodiments, the enhanced frame generation unit may include a determination subunit and an addition subunit. The determination subunit is configured to determine, based on a data coding format, a custom data field corresponding to SEI. The addition subunit is configured to add the target translation result to the custom data field, to obtain the auxiliary enhanced frame.

In some embodiments, the addition subunit may specifically be configured to: acquire speech recognition content of the live stream corresponding to the target translation result; and add the speech recognition content and the target translation result to the custom data field, to obtain the auxiliary enhanced frame.

In some embodiments, the re-encoding unit may specifically be configured to: decode the to-be-pushed target live stream, and acquire audio data of an audio stream and video data of a video stream in the to-be-pushed target live stream; insert the auxiliary enhanced frame before a specified video frame in the video data of the video stream, to obtain reference video data; the specified video frame being a key frame and/or a forward predictive coded frame in the video data of the video stream; and re-encode the audio data of the audio stream and the reference video data, to obtain the re-encoded live stream.

As an implementation, the pushing module 350 may specifically be configured to: push the target live stream if a time difference between a current time and an end time corresponding to the re-encoded live stream reaches the duration threshold.

In some embodiments, the translation processing module 320 may specifically be configured to: the translation processing module may specifically be configured to: perform translation processing on the speech recognition content corresponding to the candidate live stream, to obtain a translation result corresponding to the speech recognition content corresponding to the candidate live stream; and combine the translation result corresponding to the speech recognition content corresponding to the candidate live stream, the end time corresponding to the candidate live stream, and the target timestamp, to obtain the translation result corresponding to the candidate live stream.

In some embodiments, the live streaming translation apparatus 300 may further include an application information acquisition module and a duration threshold determination module. The application information acquisition module is configured to acquire scenario application information, the scenario application information indicating a target live streaming interaction level. The duration threshold determination module is configured to determine, based on a correspondence between live streaming interaction levels and durations, a duration corresponding to the target live streaming interaction level as the duration threshold.

A person skilled in the art can clearly understand that, for convenience and conciseness of description, for specific operating processes of the foregoing apparatuses and modules, reference may be made to the corresponding processes in the foregoing method embodiments, and details are not described herein again.

In the several embodiments provided in this application, mutual coupling between modules may be electrical, mechanical, or other forms of coupling.

In addition, the functional modules in the embodiments of this application may be integrated in one processing module, the modules may exist alone physically, or two or more modules may be integrated in one module. The integrated module may be implemented in the form of hardware, or may be implemented in the form of a software functional module.

In the solutions provided in this application, a candidate live stream may be acquired from captured live streams, where the candidate live stream is a live stream whose start time is a target timestamp and whose end time is after the target timestamp; and the target timestamp is an end time of a live stream corresponding to a previous stable translation result. Then, translation processing may be performed on speech recognition content corresponding to the candidate live stream, to obtain a translation result corresponding to the candidate live stream, and then a to-be-pushed target translation result may be determined based on the translation result corresponding to the candidate live stream and a target end timestamp of the to-be-pushed target live stream. A time difference between an end time of a live stream corresponding to the target translation result and the target end timestamp does not exceed a duration threshold.

Then, the to-be-pushed target live stream is re-encoded based on the target translation result, to obtain a re-encoded live stream, and the re-encoded live stream is pushed, to display the translated subtitles in the target translation result at the viewer end. In this way, by limiting that the time difference between the end time of the live stream corresponding to the target translation result and the target end timestamp does not exceed the duration threshold, the to-be-pushed target translation result may be determined based on the translation result corresponding to the candidate live stream, so that the target translation result can be acquired and pushed within a time period corresponding to the duration threshold, real-time performance of live streaming translation is improved, and the translation result and a video picture in which a speaker is located can be synchronously displayed.

Further, referring to FIG. 11, FIG. 11 is a block diagram of modules of a computer device according to an embodiment of this application. As shown in FIG. 11, the computer device 400 includes a processor 410, a memory 420, a power supply 430, and an input unit 440. The memory 420 stores a computer program instruction. When the computer program instruction is called by the processor 410, the method operations provided in the foregoing embodiments may be implemented. A person skilled in the art may understand that the structure of the terminal device shown in the figure does not constitute a limitation on the computer device, which may include more or fewer components than those illustrated, or some components may be combined, or a different component deployment may be used.

The processor 410 may include one or more processing cores. The processor 410 connects various parts in the entire battery management system by using various interfaces and lines, calls data stored in the memory 420 by running or executing instructions, programs, instruction sets or program sets stored in the memory 420, performs various functions and data processing of the battery management system, and performs various functions and data processing of the computer device, achieving overall control over the computer device. In some embodiments, the processor 410 may be implemented by using at least one hardware form of digital signal processing (DSP), a field-programmable gate array (FPGA), and a programmable logic array (PLA). The processor 410 may integrate one or a combination of a central processing unit 410 (CPU), a graphics processor unit 410 (GPU), and a modem. The CPU mainly processes an operating system, a user interface, an application program, and the like. The GPU is configured to manage rendering and drawing of displayed content. The modem mainly processes wireless communication. The foregoing modem may not be integrated into the processor 410, but may be implemented independently by using a communication chip.

The memory 420 may include a random access memory 420 (RAM), or may include a read-only memory 420 (ROM). The memory 420 may be configured to store an instruction, a program, code, a code set, or an instruction set. The memory 420 may include a program storage area and a data storage area. The program storage area may store instructions for implementing an operating system, instructions for implementing at least one function (for example, a touch function, a sound playback function, and an image playback function), instructions for implementing the foregoing method embodiments, and the like. The data storage area may store data (for example, a phone book and audio and video data) created by the computer device during use. Correspondingly, the memory 420 may further include a memory controller, so as to provide access of the processor 410 to the memory 420.

The power supply 430 may be logically connected to the processor 410 by using a power management system, to implement functions of managing charge, discharge, power consumption, and the like by using the power management system. The power supply 430 may further include one or more of a direct current or alternating current power supply, a re-charging system, a power failure detection circuit, a power supply converter or inverter, a power supply state indicator, and any other components.

The input unit 440, the input unit 440 may be configured to receive entered numeric or character information and generate keyboard, mouse, joystick, optical, or trackball signal input related to user settings and function control.

Although not shown, the computer device 400 may further include a display unit and the like. Details are not described herein again. Specifically, in this embodiment, the processor 410 in the computer device may load, according to the following instructions, executable files corresponding to processes of one or more computer programs into the memory 420, and the processor 410 runs the application programs stored in the memory 420, thereby implementing various method operations provided in the foregoing embodiments.

Further, referring to FIG. 12, FIG. 12 is a block diagram of modules of a computer-readable storage medium according to an embodiment of this application. As shown in FIG. 12, the computer-readable storage medium 500 stores program code 510 configured for performing operations in the method embodiments of this application. The program code 510 herein may be a computer program instruction, and the computer program instruction may be called by a processor to perform the methods described in the foregoing embodiments.

The computer-readable storage medium may be an electronic memory such as a flash memory, an electrically erasable programmable read-only memory (EEPROM), an EPROM, a hard disk, or a ROM. In some embodiments, the computer-readable storage medium includes a non-transitory computer-readable storage medium. The computer-readable storage medium 500 has storage space for program code for performing any method operation in the foregoing method. The program code may be read from one or more computer program products or written into the one or more computer program products. The program code may be, for example, compressed in a proper form.

According to an aspect of this application, a computer program product or a computer program is provided. The computer program product or the computer program includes a computer instruction. The computer instruction is stored in a computer-readable storage medium. A processor of a computer device reads the computer instruction from the computer-readable storage medium. The processor executes the computer instruction, to cause the computer device to perform the method provided in various implementations of the foregoing embodiments.

The above descriptions are merely preferred embodiments of this application, and are not intended to limit this application in any form. Although this application has been disclosed above with the preferred embodiments, the embodiments are not intended to limit this application. A person skilled in the art can make some equivalent variations or modifications to the technical content disclosed above without departing from the scope of the technical solutions of this application to obtain equivalent embodiments. Any simple alteration, equivalent change or modification made to the above embodiments according to the technical essence of this application without departing from the content of the technical solutions of this application shall fall within the scope of the technical solutions of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A live streaming translation method performed by a computer device, the method comprising:
acquiring, from captured live streams, a candidate live stream whose target timestamp is an end time of a translated live stream corresponding to a previous stable translation result;
performing translation processing on speech recognition content corresponding to the candidate live stream, to obtain a translation result corresponding to the candidate live stream;
determining a to-be-pushed target translation result from the translation result corresponding to the candidate live stream and a target end timestamp of a to-be-pushed target live stream, wherein the to-be-pushed target translation result is a translation result that is to be pushed with the target live stream;
re-encoding the to-be-pushed target live stream based on the target translation result, to obtain a re-encoded live stream; and
pushing the re-encoded live stream to be displayed with the target translation result at a viewer end.

2. The method according to claim 1, wherein a time difference between an end time of a live stream corresponding to the target translation result and the target end timestamp is no greater than a preset duration threshold, and the duration threshold representing a maximum delayed pushing duration of the target live stream.

3. The method according to claim 1, wherein the determining the to-be-pushed target translation result based on the translation result corresponding to the candidate live stream and the target end timestamp of a to-be-pushed target live stream comprises:
performing semantic analysis on the translation result corresponding to the candidate live stream, to obtain a semantic analysis result corresponding to the translation result; the semantic analysis result being configured for indicating whether a stable translation result exists in the translation result;
acquiring an end time corresponding to the candidate live stream, acquiring a target end timestamp of the to-be-pushed target live stream and a duration threshold preset for the target live stream, and taking a sum of the target end timestamp and the duration threshold as a reference time;
comparing the end time corresponding to the candidate live stream with the reference time, to obtain a comparison result; the comparison result being configured for determining whether the end time corresponding to the candidate live stream is less than the reference time; and
taking the translation result corresponding to the candidate live stream as the to-be-pushed target translation result if the comparison result indicates that the end time corresponding to the candidate live stream is less than the reference time and the semantic analysis result corresponding to the translation result indicates that a stable translation result exists in the translation result.

4. The method according to claim 1, wherein the determining a to-be-pushed target translation result from the translation result corresponding to the candidate live stream and a target end timestamp of a to-be-pushed target live stream further comprises:
determining the translation result corresponding to the candidate live stream as the to-be-pushed target translation result if the end time corresponding to the candidate live stream is equal to the reference time.

5. The method according to claim 1, wherein the method further comprises:
acquiring a new candidate live stream from the captured live streams based on the target timestamp when an end time of the candidate live stream is less than a reference time and a semantic analysis result corresponding to the translation result indicates that no stable translation result exists; and
resuming the operation of performing translation processing on speech recognition content corresponding to the candidate live stream, to obtain a translation result corresponding to the candidate live stream.

6. The method according to claim 1, wherein the re-encoding the to-be-pushed target live stream based on the target translation result, to obtain a re-encoded live stream comprises:
generating an auxiliary enhanced frame based on the target translation result; and
encoding the auxiliary enhanced frame into the to-be-pushed target live stream, to obtain the re-encoded live stream.

7. The method according to claim 1, wherein the pushing the re-encoded live stream comprises:
pushing the target live stream when a time difference between a current time and an end time corresponding to the re-encoded live stream reaches a preset duration threshold.

8. The method according to claim 1, wherein the performing translation processing on speech recognition content corresponding to the candidate live stream, to obtain a translation result corresponding to the candidate live stream comprises:
performing translation processing on the speech recognition content corresponding to the candidate live stream, to obtain a translation result corresponding to the speech recognition content corresponding to the candidate live stream; and
combining the translation result corresponding to the speech recognition content corresponding to the candidate live stream, the end time corresponding to the candidate live stream, and the target timestamp, to obtain the translation result corresponding to the candidate live stream.

9. The method according to claim 1, wherein the method further comprises:
acquiring scenario application information, the scenario application information indicating a target live streaming interaction level; and
determining, based on a correspondence between live streaming interaction levels and durations, a duration corresponding to the target live streaming interaction level as the duration threshold.

10. A computer device, comprising:
a memory;
one or more processors, coupled to the memory; and
one or more application programs stored in the memory, and the one or more application programs, when executed by the one or more processors, being configured to cause the computer device to perform a live streaming translation method including:
acquiring, from captured live streams, a candidate live stream whose target timestamp is an end time of a translated live stream corresponding to a previous stable translation result;
performing translation processing on speech recognition content corresponding to the candidate live stream, to obtain a translation result corresponding to the candidate live stream;
determining a to-be-pushed target translation result from the translation result corresponding to the candidate live stream and a target end timestamp of a to-be-pushed target live stream, wherein the to-be-pushed target translation result is a translation result that is to be pushed with the target live stream;
re-encoding the to-be-pushed target live stream based on the target translation result, to obtain a re-encoded live stream; and
pushing the re-encoded live stream to be displayed with the target translation result at a viewer end.

11. The computer device according to claim 10, wherein a time difference between an end time of a live stream corresponding to the target translation result and the target end timestamp is no greater than a preset duration threshold, and the duration threshold representing a maximum delayed pushing duration of the target live stream.

12. The computer device according to claim 10, wherein the determining the to-be-pushed target translation result based on the translation result corresponding to the candidate live stream and the target end timestamp of a to-be-pushed target live stream comprises:
performing semantic analysis on the translation result corresponding to the candidate live stream, to obtain a semantic analysis result corresponding to the translation result; the semantic analysis result being configured for indicating whether a stable translation result exists in the translation result;
acquiring an end time corresponding to the candidate live stream, acquiring a target end timestamp of the to-be-pushed target live stream and a duration threshold preset for the target live stream, and taking a sum of the target end timestamp and the duration threshold as a reference time;
comparing the end time corresponding to the candidate live stream with the reference time, to obtain a comparison result; the comparison result being configured for determining whether the end time corresponding to the candidate live stream is less than the reference time; and
taking the translation result corresponding to the candidate live stream as the to-be-pushed target translation result if the comparison result indicates that the end time corresponding to the candidate live stream is less than the reference time and the semantic analysis result corresponding to the translation result indicates that a stable translation result exists in the translation result.

13. The computer device according to claim 10, wherein the determining a to-be-pushed target translation result from the translation result corresponding to the candidate live stream and a target end timestamp of a to-be-pushed target live stream further comprises:
determining the translation result corresponding to the candidate live stream as the to-be-pushed target translation result if the end time corresponding to the candidate live stream is equal to the reference time.

14. The computer device according to claim 10, wherein the method further comprises:
acquiring a new candidate live stream from the captured live streams based on the target timestamp when an end time of the candidate live stream is less than a reference time and a semantic analysis result corresponding to the translation result indicates that no stable translation result exists; and
resuming the operation of performing translation processing on speech recognition content corresponding to the candidate live stream, to obtain a translation result corresponding to the candidate live stream.

15. The computer device according to claim 10, wherein the re-encoding the to-be-pushed target live stream based on the target translation result, to obtain a re-encoded live stream comprises:
generating an auxiliary enhanced frame based on the target translation result; and
encoding the auxiliary enhanced frame into the to-be-pushed target live stream, to obtain the re-encoded live stream.

16. The computer device according to claim 10, wherein the pushing the re-encoded live stream comprises:
pushing the target live stream when a time difference between a current time and an end time corresponding to the re-encoded live stream reaches a preset duration threshold.

17. The computer device according to claim 10, wherein the performing translation processing on speech recognition content corresponding to the candidate live stream, to obtain a translation result corresponding to the candidate live stream comprises:
performing translation processing on the speech recognition content corresponding to the candidate live stream, to obtain a translation result corresponding to the speech recognition content corresponding to the candidate live stream; and
combining the translation result corresponding to the speech recognition content corresponding to the candidate live stream, the end time corresponding to the candidate live stream, and the target timestamp, to obtain the translation result corresponding to the candidate live stream.

18. The computer device according to claim 10, wherein the method further comprises:
acquiring scenario application information, the scenario application information indicating a target live streaming interaction level; and
determining, based on a correspondence between live streaming interaction levels and durations, a duration corresponding to the target live streaming interaction level as the duration threshold.

19. A non-transitory computer-readable storage medium having program code stored therein, the program code, when executed by one or more processors of a computer device, causing the computer device to perform a live streaming translation method including:
acquiring, from captured live streams, a candidate live stream whose target timestamp is an end time of a translated live stream corresponding to a previous stable translation result;
performing translation processing on speech recognition content corresponding to the candidate live stream, to obtain a translation result corresponding to the candidate live stream;
determining a to-be-pushed target translation result from the translation result corresponding to the candidate live stream and a target end timestamp of a to-be-pushed target live stream, wherein the to-be-pushed target translation result is a translation result that is to be pushed with the target live stream;
re-encoding the to-be-pushed target live stream based on the target translation result, to obtain a re-encoded live stream; and
pushing the re-encoded live stream to be displayed with the target translation result at a viewer end.

20. The non-transitory computer-readable storage medium according to claim 19, wherein a time difference between an end time of a live stream corresponding to the target translation result and the target end timestamp is no greater than a preset duration threshold, and the duration threshold representing a maximum delayed pushing duration of the target live stream.
